(19) United States
(12) Patent Application Publication
(10) Pub. No.: US 2016/0378062 A1
(43) Pub. Date: Dec. 29, 2016

(54) HOLOGRAM DATA GENERATING METHOD, HOLOGRAM IMAGE REPRODUCTION METHOD, AND HOLOGRAM IMAGE REPRODUCTION DEVICE

(71) Applicant: OLYMPUS CORPORATION, Tokyo (JP)

(72) Inventors: Daichi WATANABE, Tokyo (JP); Yoshiaki HORIKAWA, Tokyo (JP)

(73) Assignee: OLYMPUS CORPORATION, Tokyo (JP)

(21) Appl. No.: 15/257,207

(22) Filed: Sep. 6, 2016

Related U.S. Application Data
(63) Continuation of application No. PCT/JP2015/000878, filed on Feb. 23, 2015.

(30) Foreign Application Priority Data
Mar. 20, 2014 (JP) 2014-057540

(51) Int. Cl. G03H 1/08; G03H 1/22; G03H 1/30

(52) U.S. Cl. CPC G03H 1/0808; G03H 1/0866; G03H 1/0841; G03H 1/30; G03H 1/2294; G03H 2001/0883

(57) ABSTRACT

Hologram data is generated by dividing hologram data generation area, in which hologram data is generated, into a plurality of element sub-areas, computing base hologram data that pertains to an area smaller than the hologram data generation area and that is to form an optical wavefront of an image to be reconstructed, and assigning, as hologram data of the element sub-areas4, hologram data of an entirety or a part of the area to which the base hologram data pertains. Consequently, the amount of operations for generating a hologram pattern in holographic display is reduced.

### CROSS-REFERENCE TO RELATED APPLICATION

The present application is a Continuing Application based on International Application PCT/JP2015/000878 filed on Feb. 23, 2015, which in turn claims priority to Japanese Application No. 2014-057540 filed on Mar. 20, 2014, the content of which is incorporated herein by reference in its entirety.

### TECHNICAL FIELD

The present disclosure relates to a hologram data generating method, a hologram image reproduction method (hereinafter, called a hologram image reconstruction method), and a hologram image reproduction device (hereinafter, called a hologram image reconstruction device).

### BACKGROUND

Holographic display allows display of a three-dimensional image in a visual field of an observer by generating a wavefront of an object to be displayed by forming a hologram pattern on a spatial light modulator and irradiating the formed hologram pattern with a reference beam. For formation of the hologram pattern of the object, a method of computing the wavefront at an observer's eye position that is to be generated by the object by using a computer is known (refer to, for example, Patent Literatures 1 and 2). Herein, a spatial light modulator is a device that includes numerous fine light modulation element devices arranged two-dimensionally and that is configured to modulate phase, intensity, or the like of light transmitted through or reflected from the devices. Examples of a spatial light modulator used to form a hologram pattern include a spatial light intensity modulator configured to modulate spatial intensity distribution of a wavefront of a reference beam and a spatial light phase modulator configured to modulate spatial phase distribution of a wavefront of a reference beam.

### CITATION LIST

### Patent Literatures

PTL 1: JP2011221543A
PTL 2: JP2004184609A

### SUMMARY

One of aspects of the present disclosure resides in a hologram data generation method for reconstructing a hologram image, including the steps of: dividing a hologram data generation area, in which hologram data is generated, into a plurality of element sub-areas; computing base hologram data that pertains to an area smaller than the hologram data generation area and that is to form an optical wavefront of an object to be reconstructed; and assigning, as hologram data of the element sub-areas, hologram data of an entirety or a part of the area to which the base hologram data pertains.

Preferably, the base hologram data is computed with respect to the object to be reconstructed that is located at infinity.

Preferably, the hologram data generation method further including the step of: adding hologram data having converging or diverging power.

Preferably, the hologram data having converging or diverging power is added to the hologram data of the element sub-areas each assigned with the hologram data of the entirety or the part of the area to which the base hologram data pertains.

Alternatively, the hologram data having converging or diverging power may be added to the base hologram data, and hologram data in which the hologram data having converging or diverging power is added to the element sub-areas may be generated, and the generated hologram data may be assigned to the element sub-areas. Thus, hologram data having power may be generated.

Preferably, the hologram data includes data representing phase modulation amount.

Advantageously, the element sub-areas have the same shape.

Furthermore, any of the element sub-areas having the same shape are preferably assigned with the same hologram data.

The base hologram may have the same shape as each element sub-area.

Another aspect of the present disclosure resides in a hologram image reconstruction method, including the steps of: dividing a hologram data generation area, in which hologram data is generated, into a plurality of element sub-areas; computing base hologram data that pertains to an area smaller than the hologram data generation area and that is to form an optical wavefront of an object to be reconstructed; assigning, as hologram data of the element sub-areas, hologram data of an entirety or a part of the area to which the base hologram data pertains; generating a hologram pattern based on the hologram data of the hologram data generation area; and irradiating the hologram pattern with a reference beam.

The object to be reconstructed may be located at infinity.

Preferably, the hologram image reconstruction method further includes the step of: adding hologram data having converging or diverging power.

Preferably, the hologram data having converging or diverging power is added to the hologram data of the element sub-areas each assigned with the hologram data of the entirety or the part of the area to which the base hologram data pertains.

Alternatively, the hologram data having converging or diverging power may be added to the base hologram data, and hologram data in which the hologram data having converging or diverging power may be added to the element sub-areas is generated, and the generated hologram data may be assigned to the element sub-areas. Thus, hologram data having power may be generated.

Preferably, the hologram data includes data representing phase modulation amount.

Advantageously, the element sub-areas have the same shape.

Furthermore, any of the element sub-areas having the same shape are preferably assigned with the same hologram data.

The base hologram may have the same shape as each element sub-area.

Yet another aspect of the present disclosure resides in a hologram image reconstruction device, including: a light source unit; a spatial light modulator that includes a light modulation area having a plurality of light modulation element devices and that is configured to modulate an optical wavefront from the light source unit; an operation unit configured to compute hologram data of the light modulation area; and a control unit configured to form a hologram pattern on the light modulation area included in the spatial light modulator based on the hologram data outputted from the operation unit, wherein the operation unit divides the light modulation area included in the spatial light modulator into a plurality of element sub-areas, calculates hologram data pertaining to a base hologram that has a less number of light modulation element devices than the light modulation element devices of the light modulation area and that is to form an optical wavefront of an object to be reconstructed in response to irradiation of light from the light source unit, and generates the hologram data of the light modulation area by assigning, as hologram data of the element sub-areas, hologram data pertaining to an entirety or a part of an area of the base hologram.

Preferably, the hologram data of the base hologram is derived with respect to the object to be reconstructed that is located at infinity.

The operation unit may be further configured to add hologram data having converging or diverging power.

Preferably, the hologram data having converging or diverging power is added to the hologram data of the element sub-areas each assigned with the hologram data pertaining to the entirety or the part of the area of the base hologram.

Alternatively, the hologram data having converging or diverging power may be added to the hologram data of the base hologram, and hologram data in which the hologram data having converging or diverging power may be added to the element sub-areas is generated, and the generated hologram data may be assigned to the element sub-areas. Thus, hologram data having power may be generated.

Preferably, the spatial light modulator includes a spatial light phase modulator that modulates spatial phase distribution of an incident optical wavefront.

Advantageously, the element sub-areas have the same shape.

Furthermore, any of the element sub-areas having the same shape are preferably assigned with the same hologram data.

The base hologram may have the same shape as each element sub-area.

Preferably, the element sub-areas each have a dimension that covers a circle having a diameter of 3 mm.

Preferably, the light from the light source unit is designed to be incident on each element sub-area as a reference beam having an optical wavefront of the same shape.

The light source unit may include a plurality of optical wave sources in correspondence with the element sub-areas and may also include a wavefront formation unit configured to form an optical wavefront of a beam from each optical wave source into a desired shape.

Preferably, the plurality of optical wave sources is incoherent from each other, and the coherence length is longer than wavelengths of the optical wave sources. By using a wavelength λ of an optical wave source and a full width at half maximum Δλ of the optical wave source, the coherence length l_{C} may be represented by the following formula I.

$${l}_{c} = \frac{{λ}^{2}}{Δλ} \qquad ( Formula I )$$

Furthermore, the full width at half maximum Δλ of the optical wave source preferably satisfies the following formula ii using the maximum half angle of view θ_{MAX}, the optical resolution θ_{R}, and the pitch p of the spatial light modulator.

Δλ≦2p(sin θ_{MAX}−sin θ_{R}) (Formula II)

Alternatively, the light source unit may include a less number of optical wave sources than the element sub-areas and may also include a wavefront formation unit configured to form an optical wavefront of a beam from each optical wave source into a plane shape.

Preferably, one or more of the element sub-areas are irradiated with a reference beam emitted from the spatial light modulator sequentially.

More preferably, the control unit is configured to control the light modulation element devices included in the spatial light modulator, with respect to each element sub-area individually.

### BRIEF DESCRIPTION OF THE DRAWINGS

In the accompanying drawings:

FIG. 1 illustrates a schematic configuration of a hologram image reconstruction device according to the first embodiment;

FIG. 2 illustrates an optical system using a beam emitted to one of element sub-areas included in a spatial light modulator illustrated in FIG. 1;

FIG. 3 is a flowchart illustrating a procedure of reconstructing a hologram image;

FIGS. 4A to 4C illustrate a hologram data generation method in the first embodiment;

FIG. 5 illustrates reconstruction of an image in the eyeball from a single element sub-area included in a spatial light modulator;

FIG. 6 illustrates reconstruction of an image in the eyeball from a plurality of element sub-areas included in a spatial light modulator;

FIGS. 7A to 7F illustrate control over display of hologram patterns in the first embodiment;

FIGS. 8A to 8C each illustrate a modification of an optical system by which a beam is emitted to one of element sub-areas included in a spatial light modulator;

FIGS. 9A to 9C illustrate a hologram data computation method according to the second embodiment;

FIGS. 10A to 10D illustrate modifications of how to divide a hologram data generation area;

FIGS. 11A to 11E illustrate a hologram data computation method according to the third embodiment;

FIG. 12 illustrates reconstruction of an image in the eyeball from a plurality of element sub-areas included in a spatial light modulator;

FIG. 13 illustrates a schematic configuration of a hologram image reconstruction device according to the fourth embodiment;

FIG. 14 illustrates a configuration of each of light sources included in a light source unit;

FIG. 15 illustrates control over display of hologram patterns in the fourth embodiment;

FIG. 16 illustrates a schematic configuration of a hologram image reconstruction device according to the fifth embodiment;

FIG. 17 illustrates a configuration of a fiber coupling device illustrated in FIG. 16;

FIG. 18 illustrates a schematic configuration f a hologram image reconstruction device according to the sixth embodiment;

FIG. 19 illustrates a configuration of an RGB fiber coupling device illustrated in FIG. 18;

FIG. 20A to 20K illustrate control over display of hologram patterns in the sixth embodiment;

FIG. 21 illustrates a modification of control over display of hologram patterns;

FIG. 22 illustrates a schematic configuration of a hologram image reconstruction device according to the seventh embodiment;

FIG. 23 illustrates a schematic configuration of a hologram image reconstruction device according to the eighth embodiment;

FIG. 24 illustrates a schematic configuration of a hologram image reconstruction device according to the ninth embodiment;

FIG. 25 illustrates virtual space within a computing machine used in a Gerchberg-Saxton iterative algorithm; and

FIG. 26 is a flowchart illustrating a procedure of a Gerchberg-Saxton iterative algorithm.

### DETAILED DESCRIPTION

Before a description of embodiments of the present disclosure, a description is given of the definition of terms used herein.

A hologram image herein refers to an image that may be observed through reconstruction of an optical wavefront of an object with use of a hologram technology using a computing machine. The object refers to a virtual object that is inputted to an operation unit. Reconstruction of a hologram image refers to formation of the optical wavefront that would be formed when the object is present, and through the reconstruction, an image of the object is formed on the retinas of eyeballs of an observer, and thus, an observer may observe a virtual image of the object. A hologram image is not limited to a three-dimensional image and rather refers to a two-dimensional image in which a virtual image of the object to be displayed is located far, or preferably, at infinity.

A light modulation area refers to an area within a spatial light modulator or the like which is used to reconstruct a hologram image, and an optical wavefront of an incident beam is modulated on the light modulation area. An observer observes an image reconstructed by the light modulation area. The spatial light modulator is configured to modulate spatial distribution of amplitude, phase, polarization, or the like of an incident beam. In the light modulation area, fine light modulation element devices are arranged two-dimensionally. By controlling the light modulation element devices, the spatial light modulator is capable of electrically controlling the amplitude, the phase, the polarization, or the like of a transmitted or reflected beam. Examples of the spatial light modulator include a spatial light phase modulator configured to modulate spatial phase distribution of light, a spatial light intensity modulator configured to modulate spatial amplitude distribution of light, and a device configured to modulate phase and amplitude at once.

The light modulation area of the spatial light modulator is divided into a plurality of sub-areas, and each of the sub-areas is called an element sub-area of the light modulation area. This is an area that is actually present in real space. Furthermore, an area within the operation unit that corresponds to the light modulation area within the spatial light modulator is called a hologram data generation area. The hologram data generation area is divided into a plurality of sub-areas in correspondence with the element sub-areas in real space, and each of the sub-areas is called an element sub-area of the hologram data generation area. These are virtual sub-areas within the operation unit. The light modulation area may be divided in various ways.

Moreover, hologram data is composed of respective data pieces numerically expressed, with respect to the light modulation element devices, for the hologram data generation area and the virtual element sub-areas within the virtual space in the operation unit to form a hologram pattern in the corresponding real space. Hologram data may be presented as, for example, complex amplitude distribution with respect to the spatial light phase modulator in real space. That is to say, the light modulation element devices arranged in an element sub-area in the light modulation area are in one-to-one correspondence with the minimum units (i.e., data pieces representing modulation amounts) of hologram data of the element sub-areas in the hologram data generation area. On the other hand, a hologram pattern refers to a two-dimensional distribution of physical quantity that is formed on the light modulation area and the element sub-areas in real space in correspondence with light modulation amount(s). For instance, in a spatial light phase modulator configured to modulate optical phase quantity by varying refractive index, a hologram pattern refers to refractive index distribution.

Base hologram data is composed of hologram data pieces computed in the operation unit by estimating an optical wavefront of an object to be reconstructed so that the optical wavefront is to be generated in response to irradiation by a reference beam. A base hologram area corresponding to the base hologram data is smaller than the hologram data generation area and includes element-subareas. The base hologram area is a virtual area provided for computing the hologram data.

Hologram data having converging or diverging power refers to hologram data that produces a hologram pattern exerting positive or negative refractive power. For example, some hologram data produces a refractive power distribution pattern in a concentric circular shape similarly to a Fresnel lens.

The present inventors have conducted earnest studies and invented the idea of exploiting a holographic display as a display by which a display position of a virtual image of a hologram image is located at infinity or considerably far (e.g., 4 diopters or less, where the term diopter is a unit of reciprocal distance, and 1 diopter corresponds to 1 m, and 4 diopters correspond to 0.25 m) from the display surface. By locating a virtual image of the holographic display at infinity or considerably far, even a presbyope, who has difficulty in focusing the eyes in close distances, may enjoy visibility of the displayed image without difficulty.

However, a significant amount of operations is required for computing hologram data, which is data representing modulation amounts of the light modulation element devices that correspond to a hologram pattern used to generate a wavefront of an object. As a method of computing the hologram data by using a computer, there are known a method of computing optical wavefronts at different points on an observation plane by integrating the light emitted from all the surfaces of the object, and a method of employing fast Fourier transformation. In the former computation method, it is known that, providing the number of light modulation element devices included in the spatial light modulator is N×N (where N denotes the number of the light modulation element devices in an array along the vertical and the horizontal direction), the number of operations per cycle, fir deriving the modulation amounts of all the light modulation element devices, is N²×N². In the latter computation method also, the number of operations per cycle, for deriving the modulation amounts of all the light modulation element devices, is approximately 4N² log₂ N. That is to say, as N is increased, the number of operations is increased rapidly.

For example, assume cases where the holographic display has a display surface (i.e., a surface of the spatial light modulator on which an image is reconstructed) having a size of 50 mm in length and 100 mm in width. When the wavelength of a reference beam is λ, and the pitch between individual light modulation element devices in the holographic display is p, the diffraction angle θ of primary diffracted light of the reference beam may be represented by the following formula:

$$θ = {sin}^{- 1} ( \frac{λ}{2 p} )$$

Herein, when a half angle of view of a reconstructed image (that refers to half of an angle range of a reconstructed image) is 9.5 degrees, from conditions for the primary diffracted light of the reference beam to be diffracted 9.5 degrees, the pitch between the light modulation element devices included in the spatial light modulator is 1.6 μm. When the pitch between the light modulation element devices is greater than the above, the half angle of view of a reconstructable image is decreased to less than 9.5 degrees, and the size of an image that may be reconstructed in the visual field of an observer is limited. When the light modulation element devices are arranged at a pitch of 1.6 μm, an array of the light modulation element devices included in the spatial light modulator consists of approximately 31,000 devices in the vertical direction by approximately 63,000 devices in the horizontal direction, and the number of pixels is approximately 31,000×63,000.

Accordingly, enormous computational complexity is involved for deriving hologram patterns on the spatial light modulator including numerous light modulation element devices. This is more noticeable when the display surface is enlarged to increase the size of an eye box of the holographic display or when the pitch between the light modulation element devices is reduced to increase the angle of view of an image. Thus, problems, such as time-consuming display of an image, difficulty in miniaturization and power saving due to necessity for a computer with a high operation processing ability, and a high price, arise.

Here, with reference to Patent Literature 2 (JP2004184609A), a description is given of a Gerchberg-Saxton iterative algorithm (hereinafter, expressly called the GS algorithm) that may be used to derive hologram data according to the present disclosure. Herein, for the sake of simplicity, assume that reference light is a plane wave that is incident perpendicularly on a hologram, that an object to be reconstructed is located at infinity, and that derived hologram data represents phase modulation amount.

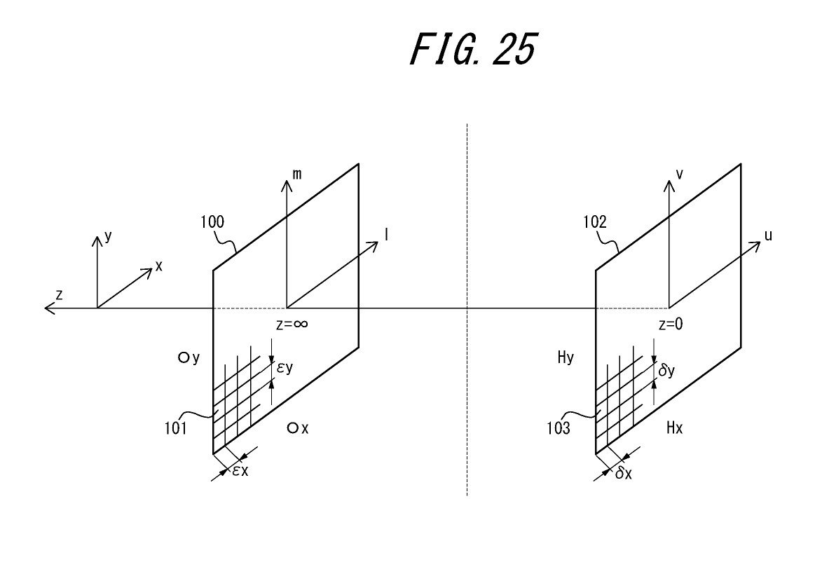

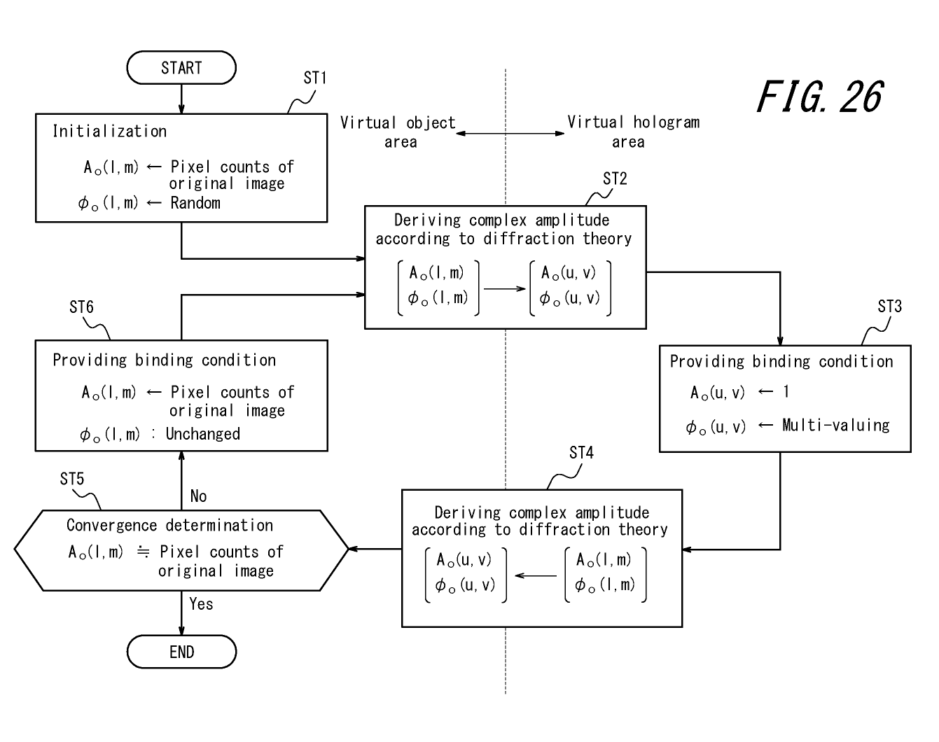

FIG. 25 illustrates the virtual space within the operation unit. Generally, in cases of a computing-machine-generated hologram, a virtual object area 100 and a virtual hologram area 102 are provided in the virtual space. In the virtual object area 100, an object to be reconstructed is disposed, and the hologram is derived by obtaining the complex amplitude of the object in the virtual hologram area 102. Although, in the GS algorithm, it is not necessary that only an object to be reconstructed be disposed in the virtual object area 100, the area is called the virtual object area 100 for convenience of illustration.

Providing that the virtual hologram area 102 is at z=0, the virtual object area 100 is located at z=∞.

The virtual object area 100 includes a set of fine elements 101 arranged in a grid on an 1-m plane, and each of the elements 101 has complex amplitude information. The amplitude and the phase of the virtual object on a coordinate (1, m) are respectively represented as A_{O} (1, m) and φ_{O} (1, m). The dimension of each element 101 in the x-axis direction is εx, and the dimension of each element 101 in the y-axis direction is εy. The grid of elements 101 consists of Ox elements 101 in the x-axis direction and Oy elements 101 in the y-axis direction.

The virtual hologram area 102 includes a set of fine elements 103 arranged in a grid on a u-v plane, and each of the elements 103 has complex amplitude information. The amplitude and the phase of the virtual object on a coordinate (u, v) are respectively represented as A_{H} (1, m) and φ_{H} (1, m). The dimension of each element 103 in the x-axis direction is δx, and the dimension of each element 103 in the y-axis direction is δy. The grid of elements 103 consists of Hx elements 103 in the x-axis direction and Hy elements 103 in the y-axis direction.

Herein, the number and the dimension of the elements 101 in the x-axis direction and the y-axis direction equal the number and the dimension of the elements 103 in the x-axis direction and the y-axis direction (Ox=Hx, Oy=Hy, εx=δx, εy=δy). Furthermore, the number of the elements 101 and 103 in the x-axis direction and the y-axis direction are each an exponentiation of 2 (Ox=Hx=2ⁿ, Oy=Hy=2^{m}, where n and m are any integers).

Additionally, the coordinate (1, m, z) of the virtual object area 100 and the coordinate (u, v, z) of the virtual hologram area 102 are used to distinguish these areas from each other, and regarding directions of coordinate axes, the l-axis and the u-axis direction correspond to the x-axis direction, and the m-axis and the v-axis direction correspond to the y-axis direction.

FIG. 26 is a flowchart of the GS algorithm.

In Step ST1, for an object to be reconstructed in the virtual object area 100, an amplitude distribution is assigned as A_{O} (1, m), and a random value is assigned as the phase distribution. In Step ST2, a complex amplitude in the virtual object area is fast Fourier transformed to obtain a complex amplitude in the virtual hologram area. In Step ST3, 1 is assigned to the amplitude distribution A_{H} (u, v) in the virtual hologram area, and the phase distribution φ_{H} (u, v) in the virtual hologram area is multi-valued according to predetermined conditions. The multi-valuing corresponds to the number of gradations available in the spatial light modulator. In Step ST4, the amplitude distribution A_{H} (u, v) and the phase distribution φ (u, v) obtained in Step ST3 are inverse fast Fourier transformed to obtain a complex amplitude in the virtual object area.

In Step ST5, when it is determined that the amplitude distribution A_{O} (1, m) obtained in Step ST4 is substantially identical to the amplitude distribution of the object to be reconstructed, the phase distribution φ_{H} (u, v) multi-valued in Step ST3 is adopted as hologram data representing phase distribution. When, in the convergence determination performed in Step ST5, it is determined that the amplitude distribution A_{O} (1, m) obtained in Step ST4 is not identical to the amplitude distribution of the object to be reconstructed, processing moves to Step ST6, where only the amplitude distribution A_{O} (1, m) obtained in Step ST4 is replaced with the amplitude distribution of the object to be reconstructed. Subsequently, a loop of Steps ST2→ST→ST4→ST5→ST6 is repeated until the condition of Step ST5 is satisfied (converged), and thus, desired final hologram data is obtained.

Additionally, although a complex amplitude in the hologram area 102 is derived from the virtual object area 100 through fast Fourier transformation for simplicity herein, Fourier transformation and diffraction integral may also be employed for deriving a complex amplitude. In these cases, the numbers of the elements 101 and 103 do not need to be exponentiations of 2. Furthermore, when diffraction integral is employed, the numbers of the elements 101 in the x-axis and the y-axis direction do not need to be equal to the numbers of the elements 103 in the x-axis and the y-axis direction, and the elements 101 and 103 may be arranged irregularly.

In the following, a description is given of embodiments of the present disclosure with reference to the drawings.

### First Embodiment

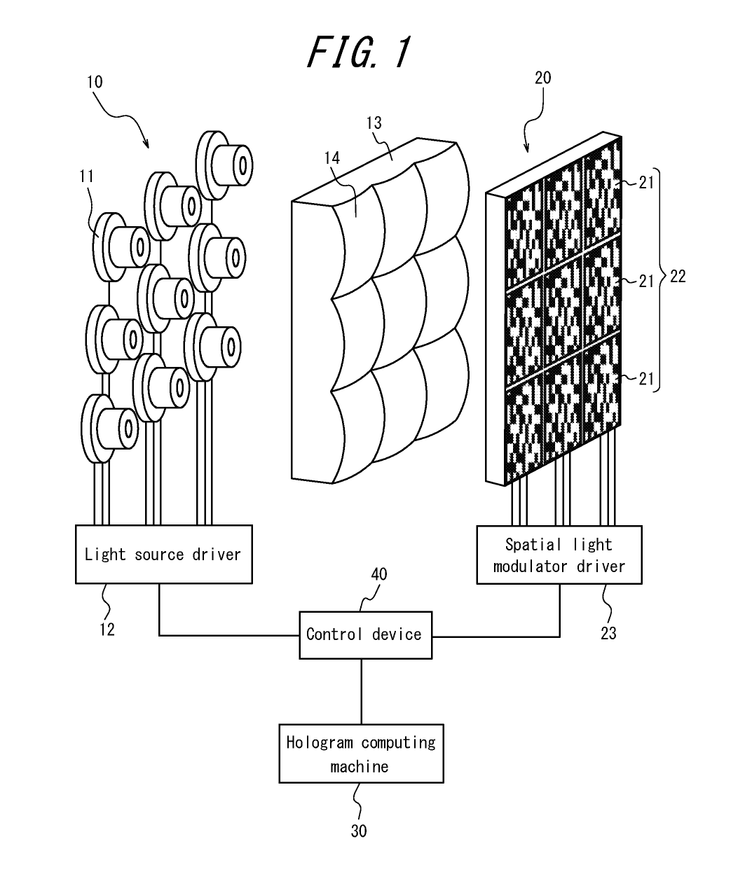

FIG. 1 illustrates a schematic configuration of a hologram image reconstruction device according to the first embodiment.

The hologram image reconstruction device includes a light source unit 10, a light source driver 12, a lens array 13 as a wavefront formation unit, a spatial light phase modulator 20 as a spatial light modulator, a spatial light modulator driver 23, a hologram computing machine 30 as the operation unit, and a control device 40 as a control unit. The light source unit 10, the lens array 13, and the spatial light phase modulator 20 are supported by a supporting element which is not illustrated, to fix the relative position. For example, the constituent elements may be located in a single housing fixedly.

The light source unit 10 includes a plurality of laser diodes (LDs) as optical wave sources that are arranged in an array. Each of the LDs 11 is connected to the light source driver 12 configured to drive the LD 11, and the light source driver 12 is connected to the control device 40. Although, in FIG. 1, 9 LDs 11 in an array of 3 rows by 3 columns are arranged in total, the number of LDs 11 is not limited to this example. On the contrary, a greater number of LDs 11 may be arranged. However, in FIG. 1, a simplified configuration with 9 LDs 11 is illustrated. The lens array 13 includes the same number of element lenses 14 as the LDs 11 and arranged in a manner such that a laser beam emitted from each LD 11 is transmitted through the corresponding element lens 14.

The spatial light phase modulator 20 includes a light modulation area 22 including numerous light modulation element devices (rectangular dots represented in black and white in the light modulation area 22 in FIG. 1) arranged in a two-dimensional array, and the spatial light phase modulator 20 is configured to modulate spatial phase distribution of the wavefront of a transmitted beam. In FIG. 1, only the light modulation area 22 of the spatial light phase modulator 20 is illustrated. The light modulation area 22 of the spatial light phase modulator 20 is divided into a plurality of the same number of element sub-areas 21 as the LDs 11. However, the light modulation area 22 of the spatial light phase modulator 20 is not necessarily divided physically, and this area is divided in terms of design of the hologram image reconstruction device. Although, in FIG. 1, 9 element sub-areas 21 are arranged in a square array of 3 rows by 3 columns, the light modulation area 22 of the spatial light phase modulator 20 may be divided into a greater number of sub-areas. In FIG. 1, similarly to the LDs 11, 9 sub-areas are illustrated for the sake of simplicity. The spatial light modulator driver 23 is connected to the spatial light phase modulator 20, and the spatial light modulator driver 23 is connected to the control unit 40. The spatial light modulator driver 23 is capable of controlling the element sub-areas 21 independently. As the spatial light phase modulator, for example, a transmissive liquid crystal display (LCD) that performs phase modulation by using liquid crystal is known.

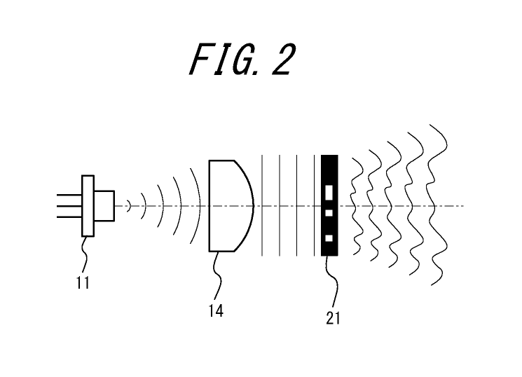

The element sub-areas 21 of the spatial light phase modulator 20, the LDs 11 of the light source unit 10, and the element lenses 14 of the lens array 13 are in one-to-one correspondence. FIG. 2 illustrates an optical system using a beam emitted to one of the element sub-areas 21 included in the spatial light phase modulator 20 illustrated in FIG. 1. The corresponding LD 11, the corresponding element lens 14, and the element sub-area 21 are arranged in a manner such that the center of a light emitting surface of the corresponding LD 11 and the center of gravity of the element sub-area 21 of the spatial light phase modulator 20 are aligned on an optical axis of the element lens 14. Furthermore, the LD 11 is located in a front focal position of the element lens 14, and a diverging beam emitted from the LD 11 is transformed, through the element lens 14, into a parallel beam that is to be incident perpendicularly on the element sub-area 21. The beam incident on the element sub-area 21 is subject to phase modulation by the light modulation element device to be formed into a display beam having a two-dimensional phase distribution.

The hologram computing machine 30 calculates hologram data, which is composed of numerically expressed data pieces representing phase modulation amounts of the light modulation element devices included in the spatial light phase modulator 20. The control device 40 is connected to the hologram computing machine 30 and is configured to drive the spatial light modulator driver 23 based on hologram data outputted from the hologram computing machine 30 and form a hologram pattern on the light modulation area 22 of the spatial light phase modulator 20. The control device 40 is also configured to drive the light source driver 12 to cause the light source unit 10 to emit light source wave of a reference beam in conjunction with rewriting of a hologram pattern on the spatial light phase modulator 20.

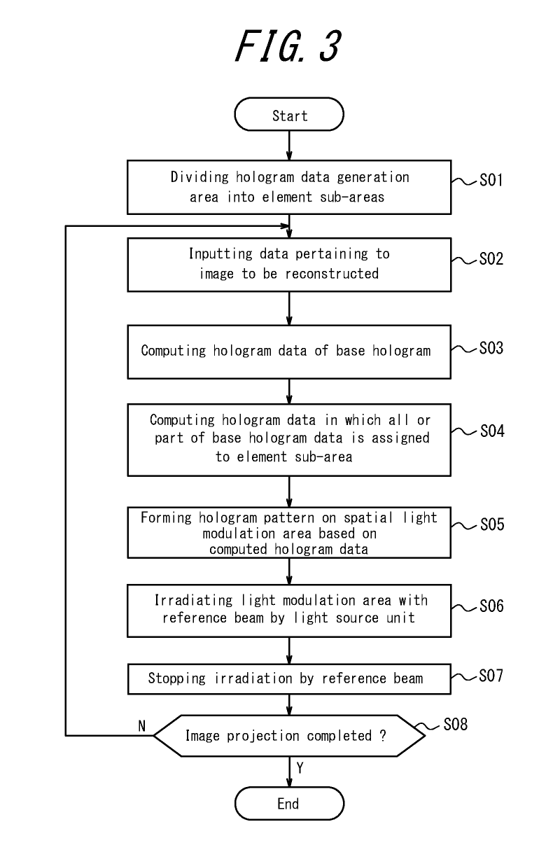

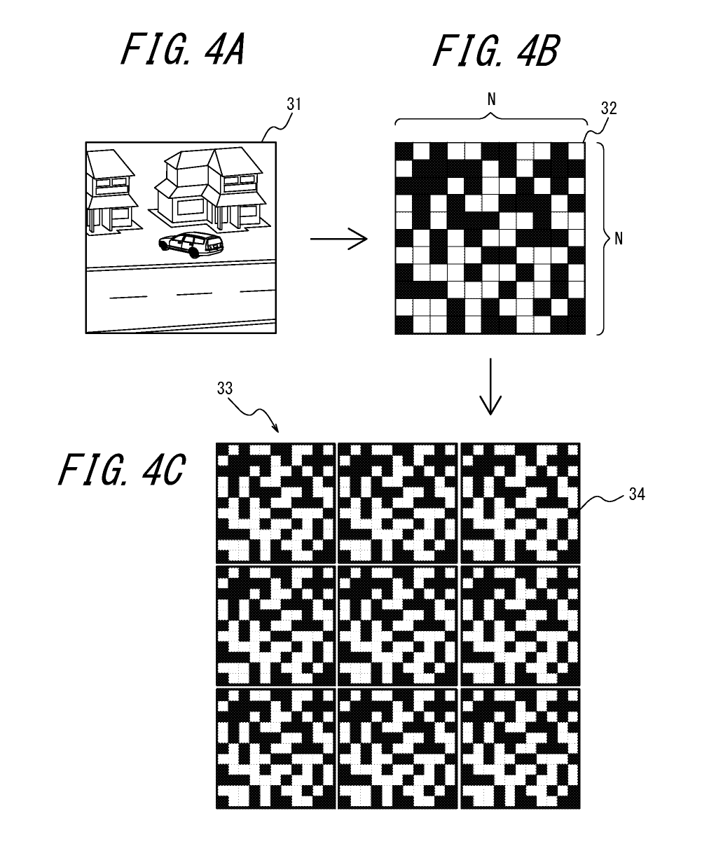

Next, a description is given of a method of reconstructing a hologram image. FIG. 3 is a flowchart illustrating a procedure of reconstructing a hologram image. FIGS. 4A to 4C illustrate a hologram data computation method according to the first embodiment. To start with, the hologram computing machine 30 includes a hologram data generation area 33, which is a virtual data area corresponding to the light modulation area 22 of the spatial light phase modulator 20, and the hologram data generation area 33 is divided into a plurality of virtual element sub-areas 34 (Step S01). The virtual element sub-areas 34 are in correspondence with the element sub-areas 21 of the spatial light phase modulator 20. This step does not need to be performed each time a hologram image is reconstructed, and a way of dividing the hologram data generation area may be determined in advance.

Next, data pertaining to an image 31 to be reconstructed (an object to be reconstructed) is inputted to the hologram computing machine 30 by an input unit which is not illustrated (Step S02). The image 31 does not need to be inputted externally and may be generated within the hologram computing machine 30. Herein, the image 31 may be data on a two-dimensional plane or data of a three-dimensional object. Next, a base hologram area 32, which has the same shape and dimension as each element sub-area 34, is provided within the hologram computing machine 30.

The hologram computing machine 30 computes data pertaining to a modulation amount used to modulate an optical wavefront of a reference beam so that a two-dimensional array of virtual light modulation element devices located in the base hologram area 32 may form, when being irradiated with the reference beam in the form of a parallel wave having the same wavelength as the LD 11, an optical wavefront that is substantially the same as an optical wavefront formed by the image 31, located at infinity, through diffraction, and the computed data is defined as hologram data (hereinafter, called base hologram data) of the base hologram area 32 (Step S03). The base hologram is derived by, for example, the GS algorithm using the aforementioned fast Fourier transformation.

Next, the hologram computing machine 30 assigns all the base hologram data of the base hologram area 32 to hologram data (i.e., element hologram data) of the element sub-area 34 (Step S04). Then, the same element hologram data is arranged in the vertical and the horizontal direction in 3 rows by 3 columns, and thus, hologram data of the hologram data generation area 33 is generated. Additionally, each of rectangular points in white or black included in the hologram data of the element sub-area 34 and the hologram data of the hologram data generation area 33 in FIGS. 4A to 4C represents the minimum unit of data that corresponds to a phase modulation amount of the corresponding light modulation element device in real space. Hologram data does not necessarily need to have binary values of black and white as illustrated in FIGS. 4A to 4C and may have, for example, a greater number of values.

Subsequently, based on the hologram data of the hologram data generation area 33 outputted by the hologram computing machine 30, the control device 40 forms a hologram pattern on the light modulation area 22 of the spatial light phase modulator 20 illustrated in FIG. 1 via the spatial light modulator driver 23 (Step S05). That is to say, the control device 40 forms a two-dimensional distribution of phase modulation amount by controlling the light modulation device elements. As a result, in each element sub-area of the spatial light phase modulator 20, the same hologram pattern is formed in accordance with the hologram data of the element sub-area 34 in the hologram data generation area 33 that is computed by the hologram computing machine 30.

Additionally, the hologram computing machine 30 may compute the hologram data of the element sub-area 34 and transmit the computed hologram data to the control device 40, and the control device 40 may generate the hologram data of the hologram data generation area 33 by duplicating the hologram data of the element sub-area 34. Alternatively, the control device 40 may transmit the hologram data of the element sub-area 34 to the spatial light modulator driver 23, and the spatial light modulator driver 23 may be configured to control each element sub-area 21 of the spatial light phase modulator 20 independently and to form, in accordance with the hologram data of the control sub-area 34, the hologram pattern for each element sub-area 21 parallelly by using the same data.

FIG. 5 illustrates reconstruction of an image in the eyeball 50 from a single element sub-area 21 of the spatial light phase modulator 20. Since the hologram pattern in each element sub-area 21 is computed by the hologram computing machine 30 to form the optical wavefront that the virtual image 31, located at infinity, is expected to form, when the element sub-area 21 is irradiated with the reference beam, the display beam, after being modulated and transmitted through the element sub-area 21, forms a virtual image of the image 31 at infinity (Step S06). Since the virtual image of the image 31 is located at infinity, the beam formed as being emitted from a single point of the image 31 is emitted from the element sub-area 21 toward the eyeball 50 in the form of a parallel beam. Furthermore, an angle distribution of the beam emitted from the element sub-area 21 equals a visual angle of an observer with respect to the image.

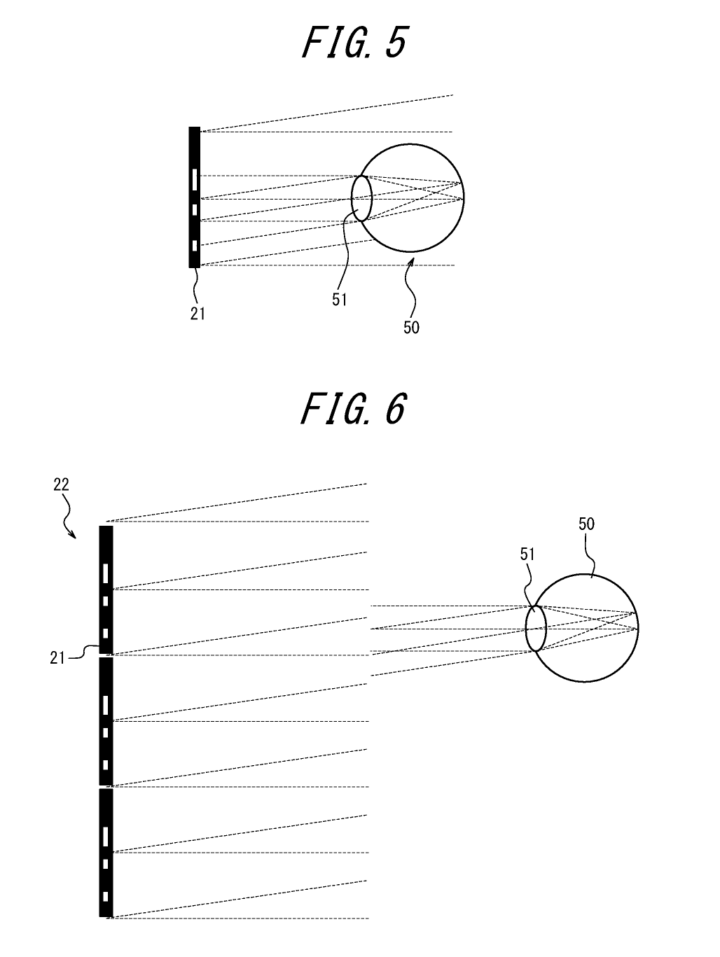

FIG. 6 illustrates reconstruction of an image in the eyeball 50 from a plurality of element sub-areas 21 of the spatial light phase modulator 20. In each element sub-area 21, the same hologram pattern is formed, and the display beam generated by each hologram pattern is a virtual image at infinity. Accordingly, a beam corresponding to the single point of the image 31 produces a parallel beam across adjacent element sub-areas 21 and is focused at a single point in the eyeball 50. Accordingly, even when the beam that is incident on the pupil 51 spans over a plurality of element sub-areas 21 or, in cases where relative positions of the element sub-areas 21 and the eyeball 50 are changed, extends across a border between adjacent element sub-areas 21, a single image without any missing or misaligned part may be observed.

Subsequently, irradiation by the reference beam is stopped, and by doing so, reconstruction of the hologram image is stopped (Step S07). With the above procedure, the image 31 is displayed on the eyeball 50 of an observer as the virtual image located at infinity. Furthermore, by repeating Steps S02 through S07 while changing images 31 to be reconstructed sequentially (Step S08), moving images may be displayed.

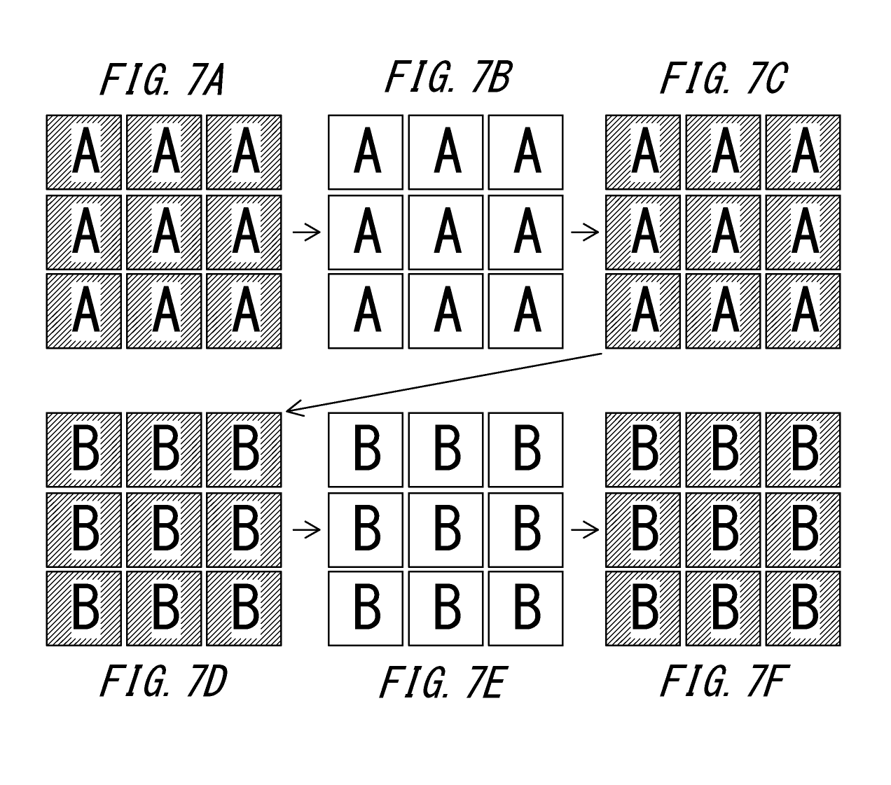

FIGS. 7A to 7F illustrate control over display of hologram patterns in the first embodiment. Frames in an array of 3×3 represent element sub-areas 21, and presence of a hatching pattern indicates presence of emission of a display beam. In a display method according to the figure, firstly, as illustrated in FIG. 7A, a hologram pattern of an image A is formed on the element sub-areas 21, and as illustrated in FIG. 7B, the formed hologram pattern is irradiated with a reference beam to reconstruct a hologram image of the image A, and subsequently, as illustrated in FIG. 7C, the reference beam is stopped. Subsequently, as illustrated in FIG. 7D, a hologram pattern of an image B is formed on the element sub-areas 21, and as illustrated in FIG. 7E, the formed hologram pattern is irradiated with the reference beam to reconstruct a hologram image of the image B, and then, as illustrated in FIG. 7F, the reference beam is stopped. By repeating the above procedure while images to be displayed are sequentially changed, moving images may be reconstructed on the eyeball 50 of an observer. Additionally, in this display method, FIGS. 7A and 7D correspond to Step S05, FIGS. B and E correspond to Step S06, and FIGS. 7C and 7F correspond to Step S07.

Furthermore, Steps S01 through S04, which are processing steps performed in the hologram computing machine 30, are performed while irradiation by the reference beam is not present, for example, in and between FIGS. 7C and 7D. However, these processing steps may also be implemented in parallel with control, performed by the control device 40, over display of the spatial light phase modulator 20. Alternatively, prior to hologram reconstruction in the spatial light phase modulator 20, the hologram computing machine 30 may repeat processing of Steps S02 through S04 and compute hologram data corresponding to a plurality of images 31 and store the computed hologram data in a memory which is not illustrated.

As described above, the hologram image reconstruction device according to the present disclosure allows observation of still or moving hologram images reconstructed by optical wavefronts of images 31. The amount of operations required to compute hologram data of the base hologram area 32 occupies most of the amount of operations performed in the hologram data generation area 33 for hologram data generation, and therefore, the amount of operations is significantly reduced compared with cases where hologram data is computed for the entire hologram data generation area 33.

In the present embodiment, the hologram data generation area 33 is divided into 3×3 virtual space element sub-areas 34, and the base hologram area 32 has the same shape as each element sub-area 34. Providing that the element sub-areas 21 of the spatial light phase modulator 20 in real space that correspond to the element sub-areas 34 each include N×N phase modulation device elements, the number of operations for the aforementioned computation of base hologram data according to the GS algorithm using fast Fourier transformation is approximately 4N² log₂ N×Cycle. Thus, compared with cases where computation according to the GS algorithm is performed for the entire hologram data generation area 33 corresponding to the 3N×3N phase modulation device elements, the amount of operations is approximately 1/9×log_{N} 3N. Although, in the above embodiment, the light modulation area 22 of the spatial light phase modulator 20 and the hologram data generation area 33 corresponding to the light modulation area 22 in virtual space are divided into 3×3 element sub-areas 21 and 3×3 element sub-areas 34 for the sake of simplicity, these areas may be divided more minutely. An image 31 may be observed without a decrease in optical resolution, as long as each element area 21 of the spatial light phase modulator 20 has a dimension by which the pupil of an observer is covered, that is to say, a dimension that covers a circle having a diameter of 3 mm. As the number of sub-areas as a result of division is increased, the effect of reducing the computational complexity becomes greater.

As has been described, the base hologram data that pertains to the base hologram area 32 smaller than the hologram data generation area 33 and that forms the optical wavefront of an image 31 to be reconstructed is computed, and the hologram data of the base hologram data area is assigned as hologram data of each element sub-area 34. Accordingly, the amount of operations for generating a hologram pattern in holographic display is significantly reduced. Furthermore, the spatial light modulator driver 23 is configured to control the element sub-areas 21 independently, that is to say, to drive the element sub-areas 21 in parallel. Accordingly, a clock frequency used to operate the spatial light modulator may be reduced.

Various modifications and changes may be made to the present embodiment. Examples of these are described blow.

### (Modifications)

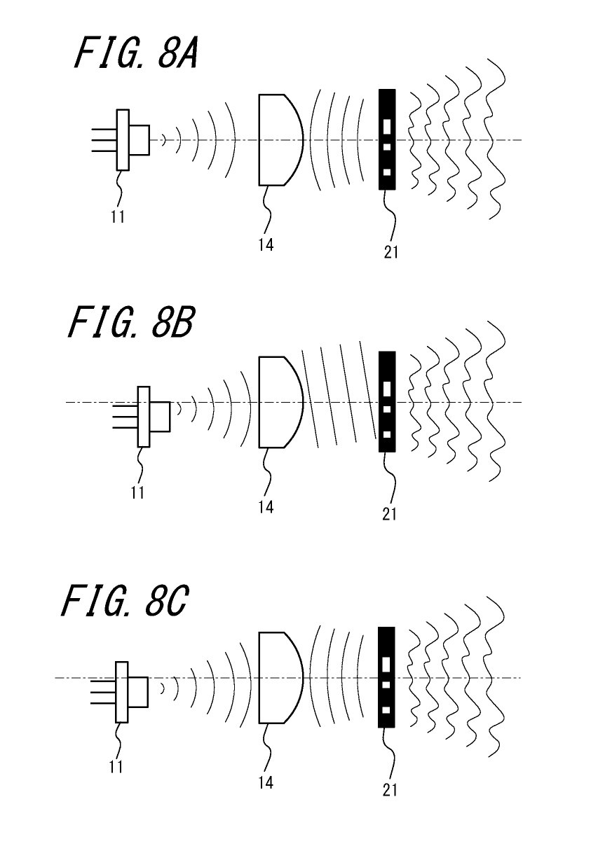

FIGS. 8A to 8C each illustrate a modification of an optical system by which a beam is emitted to one of element sub-areas 21 of the spatial light modulator 20. In the embodiment described above, the reference beam emitted from an LD 11 is transformed into a parallel beam through the corresponding element lens 14, and the parallel beam is emitted to the element sub-area 21. However, the arrangement and the configuration of the optical system used to emit the reference beam are not limited to the above embodiment. For example, as illustrated in FIG. 8A, the LD 11 may be located in a position farther from the element lens 14 than the front focal position of the element lens 14, so that the optical wavefront refracted by the element lens 14 is transformed into a converging spherical wave. Alternatively, an anamorphic lens may be used as the element lens 14 to provide a reference beam having an anamorphic-shape optical wavefront. In this way, the light source unit 10, the lens array 13, and the spatial light phase modulator 20 may be arranged flexibly. FIG. 8B illustrates an example in which the LD 11 is arranged in misalignment with an optical axis connecting the centers of gravity of the element lens 14 and the element sub-area 21. Such an arrangement of the light source may be adopted, for example, when a plurality of LDs 11 having different wavelengths for color display is located in the vicinity of the optical axis. FIG. 8C illustrates an arrangement of the optical system that combines features of arrangement of FIGS. 8A and 8B. In cases of FIGS. 8A to 8C also, each element sub-area 21 is preferably irradiated with the same optical wavefront. Accordingly, each set of an LD 11, the corresponding element lens 14, and the corresponding element sub-area 21 preferably has the same relative relations. In cases of FIG. 8A to 8C described above, the hologram computing machine 30 is programmed to compute the base hologram data that reconstructs the optical wavefront in consideration of the shape of the optical wavefront of the emitted reference beam.

### Second Embodiment

In the second embodiment, the light modulation area 22 included in the spatial light phase modulator 20 is divided into the element sub-areas 21 having regular hexagonal honey comb shapes, not square shapes. Furthermore, the arrangement of the LDs 11, and the arrangement and the shape of the element lenses 14 included in the lens array 13 are changed in accordance with the element sub-areas 21. Illustration of the physical shapes and arrangements of these constituent elements is omitted. However, the arrangements and relative relations of connection of the light source unit 10, the light source driver 12, the lens array 13, the spatial light phase modulator 20, the spatial light modulator driver 23, the hologram computing machine 30, the control device 40, and others are the same as those in the first embodiment.

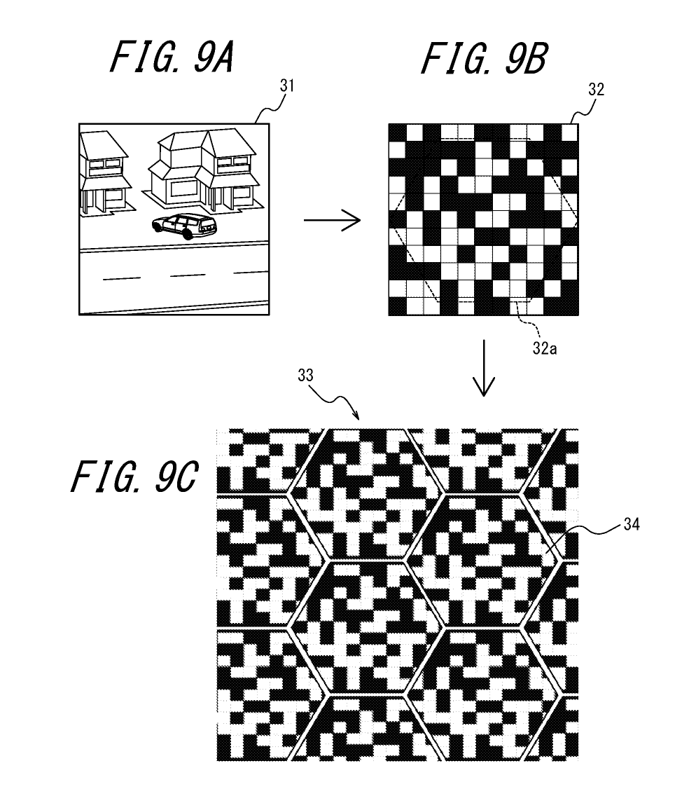

The second embodiment differs from the first embodiment in terms of contents of operation processing performed in the hologram computing machine 30. FIGS. 9A to 9C illustrate a hologram data computation method according to the second embodiment. The element sub-areas 34 of the hologram data generation area 33 within the hologram computing machine 30 each have a regular hexagonal shape that is the same as the corresponding element sub-area 21 of the spatial light phase modulator 20. On the other hand, the base hologram area 32 does not have the same shape as each element sub-area 34 and has a square shape with a dimension by which the element sub-area 34 is covered. However, the base hologram area 32 is smaller than the hologram data generation area 33.

Similarly to the first embodiment, the hologram computing machine 30 computes hologram data of the base hologram area 32 illustrated in FIG. 9B with respect to the image 31 illustrated in FIG. 9A. Then, hologram data pertaining to a part 32a of the base hologram area 32 is assigned as hologram data of each element sub-area 34 as illustrated in FIG. 9C. Thus, hologram data of the hologram data generation area 33 that includes the same hologram data in each element sub-area 34 is generated.

In accordance with the hologram data of the hologram data generation area 33, a hologram pattern is formed on the light modulation area 22 of the spatial light phase modulator 20, and when the hologram pattern is irradiated with a reference beam, the image 31 may be observed as a virtual image located at infinity as in the first embodiment. In the present embodiment also, the fact that the base hologram area 32 is smaller than the hologram data generation area 33 means that the number of virtual light modulation element devices included in the base hologram area 32 is less than the number of virtual light modulation element devices included in the hologram data generation area 33, that is to say, the number of the light modulation element devices included in the light modulation area 22 of the spatial light phase modulator 20. Accordingly, the amount of operations required for computing hologram data is reduced.

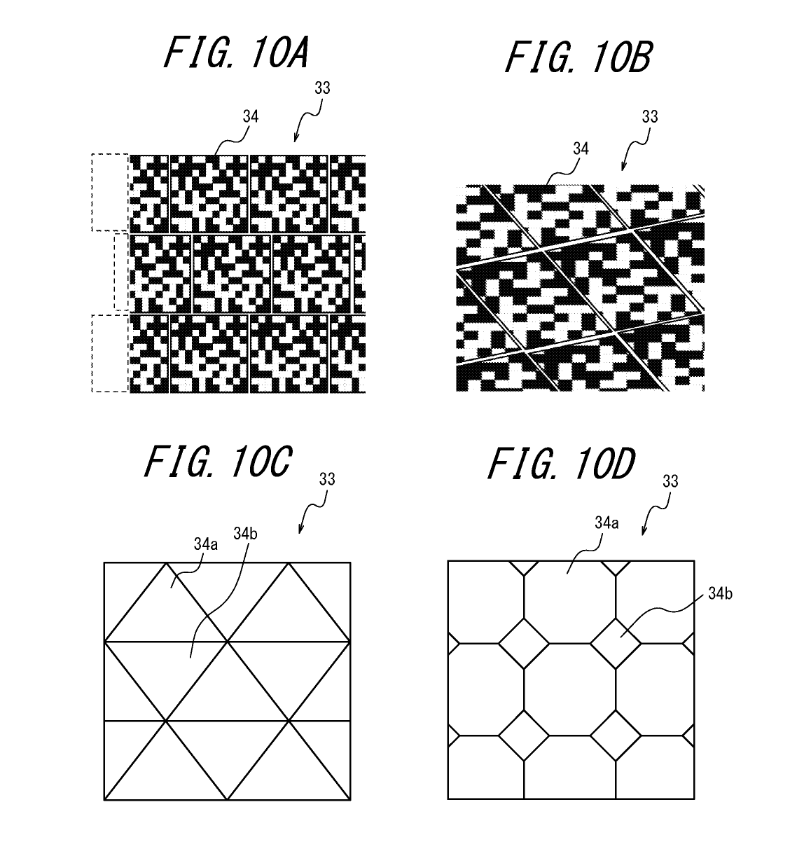

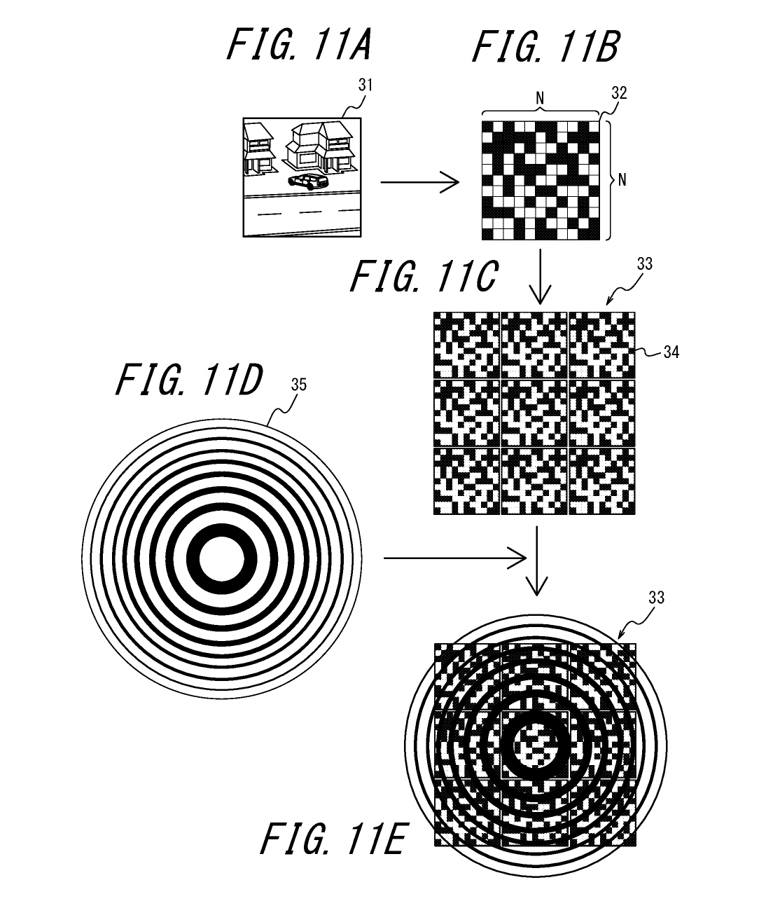

Additionally, the hologram data generation area 33 may be divided into the element sub-areas 34 in not only square or hexagonal shapes but various other shapes (That is to say, the corresponding light modulation area 22 may also be divided into various shapes). FIGS. 10A to 10D illustrate modifications of how the hologram data generation area 33 is divided. In FIGS. 10A and 10B, the element sub-areas 34 having the same square and parallelogram shapes are tightly arranged on planes. In this way, the element sub-areas 34 preferably have the same polygonal shape, such as square, regular hexagonal, rectangular, and parallelogram shapes, or a shape obtained by enlarging or contracting these shapes in one direction. In this case, it is only necessary to compute a single piece of base hologram data, and the amount of operations is reduced. Furthermore, forming the reference beam having a uniform light intensity with respect to the corresponding element sub-areas 21 of the spatial light phase modulator 20 is facilitated.

FIGS. 10C and 10D each include 2 types of element sub-areas 34a and 34b having different shapes. The element sub-areas 34a, 34b are each assigned with hologram data pertaining to a partial area of the same base hologram area 32. At this time, an area whose hologram data is assigned to each element sub-area 34a may overlap or non-overlap with an area whose hologram data is assigned to each element sub-area 34b. However, for the element sub-areas 34a, 34b having different shapes, different base hologram areas 32 may also be defined, and different base hologram data may be computed.

The base hologram area 32 may have not only a square shape but various other shapes. Preferably, the elements in the base hologram area are arranged in a grid on an x-y plane, and the number of the elements in the x-axis direction and the number of the elements in the y-axis direction are each an exponentiation of 2. Additionally, number of the elements in the x-axis direction does not necessarily need to be the same as the number of the elements in the y-axis direction.

### Third Embodiment

FIGS. 11A to 11E illustrate a hologram data computation method of the hologram image reconstruction device according to the third embodiment. The present embodiment differs from the first embodiment only in terms of computation method implemented in the hologram computing machine 30. The physical configuration of the hologram image reconstruction device is the same as that in the first embodiment. According to the present embodiment, similarly to the first and the second embodiment, the hologram computing machine 30 is inputted with an image 31 to be reconstructed, computes hologram data of the base hologram area 32, assigns the entirety or a part of the computed base hologram data to each element sub-area 34, and computes hologram data of the hologram data generation area 33 (FIGS. 11A to 11C).

The hologram computing machine 30 is also configured to hold, or, be inputted externally with, hologram data representing hologram having converging or diverging power and to add the held or inputted hologram data to hologram data of the hologram data generation area 33. As illustrated in FIG. 11D, hologram data 35, which has diverging power and has a concentric circular shape corresponding to a hologram pattern having a negative refractive power, is added to hologram data of the hologram data generation area 33, and as illustrated in FIG. 11E, hologram data of the hologram data generation area 33 that has diverging power is obtained.

When the spatial light phase modulator 20 is capable of phase modulation in the range of 0 to 2π, in cases where the range of modulation amount exceeds 2π as a result of addition of the hologram data 35 having diverging power, the hologram computing machine 30 subtracts 2π and regulates the modulation amount within the range of 0 to 2π for outputting. Alternatively, when the spatial light phase modulator 20 is capable of phase modulation in the range of 0 to 4π, the hologram data 35 having diverging power only has to be added to hologram data that the hologram computing machine 30 computes.

By doing so, the optical wavefront of the display beam is changed, and a position in which a hologram image of the image 31 is displayed may be displaced from infinity. For example, when hologram data having diverging power is added, the position in which the hologram image is displayed is displaced closer to an observer. Additionally, the refractive power of hologram data to be added does not necessarily be negative and may be positive. In this case, the display beam at a predetermined image height is a converging beam, which allows, fir example, a far-sighted observer to observe the hologram image without the need of straining the eyes. Hence, according to the present embodiment, by setting hologram data to be added as appropriate, the position in which the hologram image is displayed may be displaced to a position on which an observer may focus the eyes easily.

Although, in the above description, hologram data having diverging power is added to hologram data of the hologram data generation area 33, the hologram data having diverging power may also be added to the base hologram area 32 or to hologram data of the element hologram area 34.

Besides, similarly to the first embodiment, even when a beam that is incident on the pupil 51 spans over a plurality of element sub-areas 21 or, in cases where relative positions of the element sub-areas 21 and the eyeball 50 are changed, extends across a border between adjacent element sub-areas 21, a single image without any missing or misaligned part may be observed.

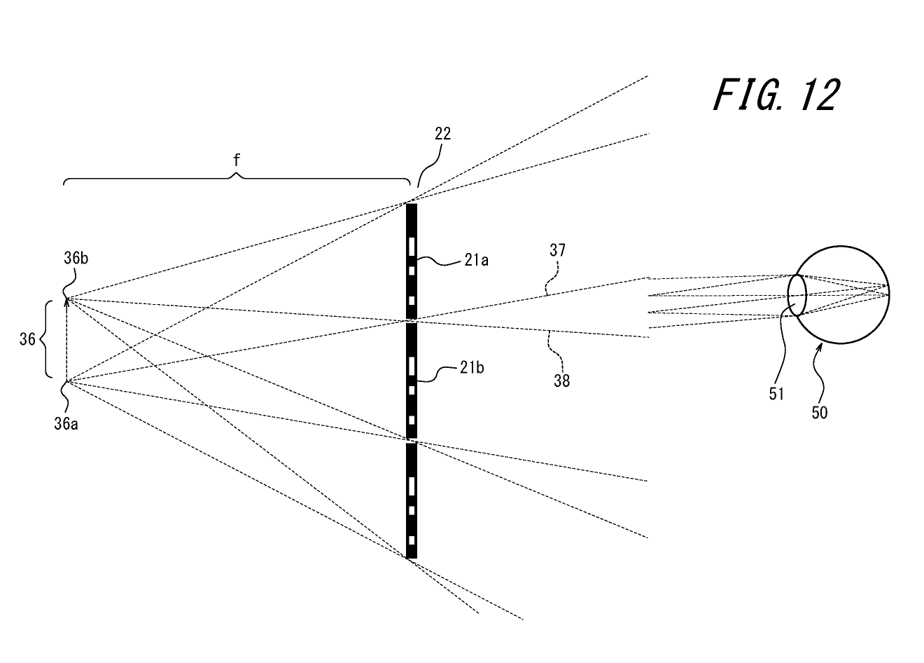

This is illustrated with reference to FIG. 12.

FIG. 12 illustrates reconstruction of an image in the eyeball 50 from element sub-areas 21a and 21b included in the spatial light modulator 20. In the light modulation area 22 of the spatial light modulator 20, a hologram pattern with a focal distance of f is formed, and hologram data having a negative refractive power is added to the hologram pattern. This is optically equivalent to cases where a concave lens having a focal distance of f is disposed with respect to the hologram area in the first embodiment. Accordingly, as illustrated in FIG. 12, wavefront portions emitted from the element sub-areas 21a, and 21b are propagated at the corresponding image heights image without overlapping with each other and substantially without any space. For example, a wavefront portion that reconstructs a starting side 36a of a reconstructed image 36 indicated by an arrow is emitted from the element sub-area 21a on the upper side and from the element sub-area 21b on the lower side, with a border 37 being defined as a boundary. Similarly, a wavefront portion that reconstructs an ending side 36b of the reconstructed image 36 indicated by the arrow is emitted from the element sub-area 21a on the upper side and from the element sub-area 21b on the lower side, with a border 38 being defined as a boundary. Accordingly, a beam corresponding to a single point of the image 31, even across adjacent element sub-areas 21a, 21b, forms an image at a single point in the eyeball 50. Accordingly, even when a beam that is incident on the pupil 51 spans over a plurality of element sub-areas 21 or, in cases where relative positions of the element sub-areas 21 and the eyeball 50 are changed, extends across a border between adjacent element sub-areas 21, a single image without any missing or misaligned part may be observed.

### Fourth Embodiment

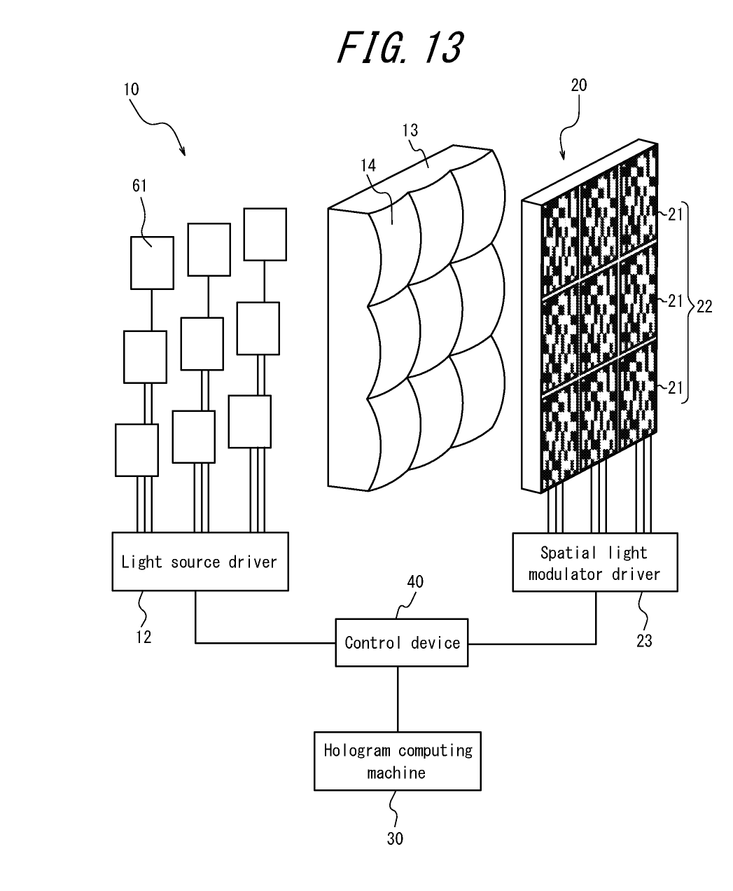

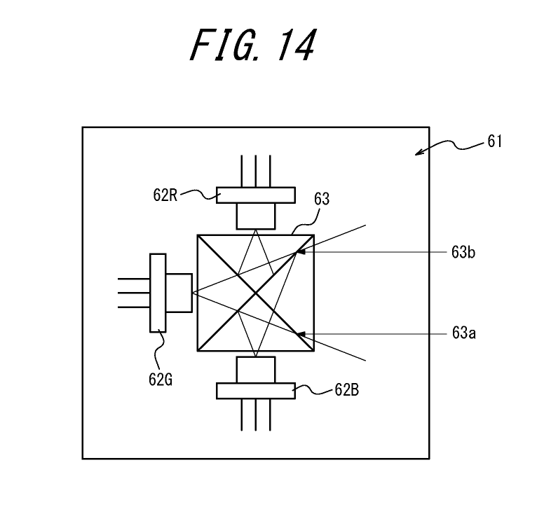

FIG. 13 illustrates a schematic configuration of a hologram image reconstruction device according to the fourth embodiment. The hologram image reconstruction device according to the fourth embodiment includes RGB light sources 61 instead of the LDs 11 included in the light source unit 10 according to the first embodiment. FIG. 14 illustrates a configuration of each RGB light source 61 included in the light source unit 10 illustrated in FIG. 13. The RGB light source 61 includes an LD 62R, an LD 62G, and an LD 62B, which respectively emit red, green, and blue laser beams, and also includes a quarterly partitioned dichroic mirror 63. The quarterly partitioned dichroic mirror 63 includes a dichroic mirror surface 63a, which reflects red only, and a dichroic mirror surface 63b, which reflects blue only. The LDs 62R, 62G, and 62B are arranged to face to different three surfaces of the dichroic mirror 63. A laser beam emitted from the red LD 62R is reflected by the dichroic mirror surface 63a and emitted through a surface that opposes a surface on which the LD 62G is located. Similarly, a laser beam emitted from the blue LD 62B is reflected by the dichroic mirror surface 63b and emitted through the surface that opposes the surface on which the LD 62G is located. A laser beam emitted from the green LD 62G is emitted, as it is, through the surface that opposes the surface on which the LD 62G is located. The LDs 62R, 62G, and 62B are arranged in a manner such that a laser beam emitted from each of the LDs 62R, 62G, and 62B is to be incident on the corresponding element lens 14 included in the lens array 13 along the optical axis of the element lens 14. Other parts of the configuration are the same as the first embodiment, and the same constituent elements are denoted by the same reference numerals, and a description thereof is omitted. In the present embodiment also, the method of computing hologram data corresponding to a hologram pattern on the element sub-areas 21 is the same as that in the first embodiment.

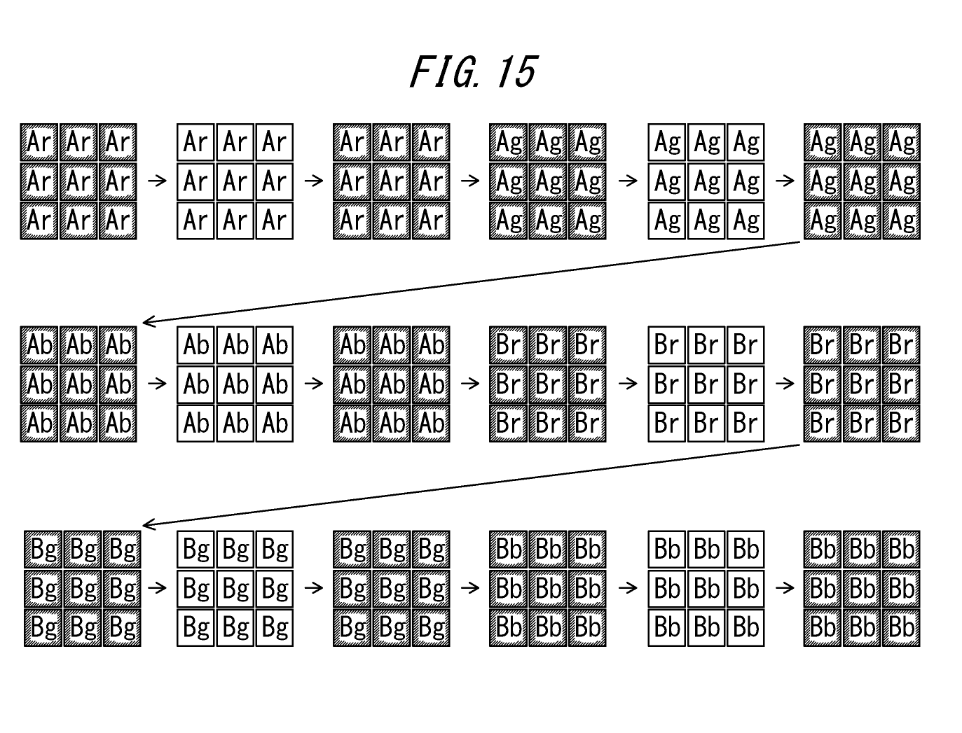

The hologram image reconstruction device with the above configuration is capable of reducing the amount of operations for forming a hologram pattern and, moreover, is capable of reconstructing a color image by switching between the LDs 62R, 62G, and 62B sequentially. FIG. 15 illustrates control over display of hologram patterns in the fourth embodiment. In this figure, reference numerals A and B denote images, and letters r, g, and b respectively denote red, green, and blue components of the images. Firstly, with respect to the image A, a red hologram pattern Ar is formed in each element sub-area 21, and subsequently, the red hologram pattern Ar is irradiated with a red reference beam to emit a red display beam, and thus, the red component of the image A is reconstructed. After that, the red reference beam is stopped, and the hologram pattern in the element sub-area 21 is switched to a green hologram pattern Ag. The green hologram pattern Ag is irradiated with a green reference beam to emit a green display beam, and thus, the green component of the image A is reconstructed. Similarly, the blue component of the image A is reconstructed. Subsequently, the image to be reconstructed is replaced with the image B, and the similar control over display is performed. In this way, a hologram image is reconstructed by the time-division method. By changing images to be displayed, color moving images may be reconstructed.

Additionally, the order of switching the colors is not limited to r→g→b. For example, g→r→b may be envisaged.

### Fifth Embodiment

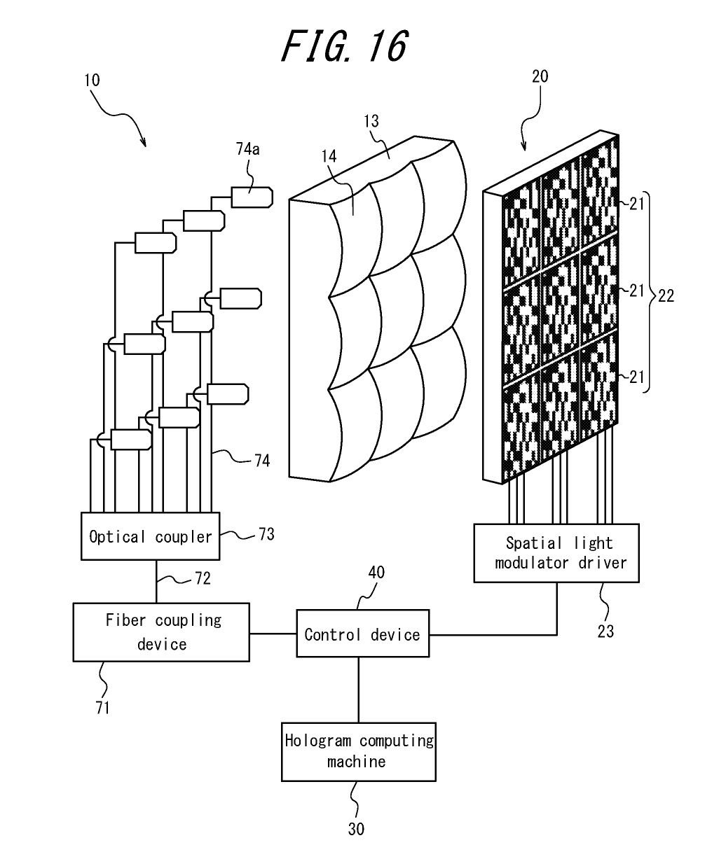

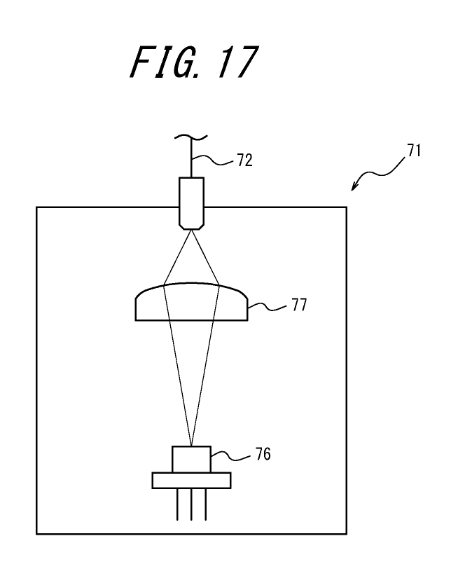

FIG. 16 illustrates a schematic configuration of a hologram image reconstruction device according to the fifth embodiment. The hologram image reconstruction device according to the fifth embodiment differs from those according to the first to the fourth embodiment in terms of configuration of the light source unit 10. The light source unit 10 in the fifth embodiment includes a fiber coupling device 71, an optical coupler 73, and waveguides 72 and 74. FIG. 17 illustrates a configuration of the fiber coupling device 71 illustrated in FIG. 16. The fiber coupling device 71 includes an LD 76 and a condensing lens 77. The LD 76 is controlled directly by the control device 40. Diverging light emitted from the LD 76 is collected to an end surface of the waveguide 72 through the condensing lens 77, and the light coupled to the waveguide 72 is propagated through the waveguide 72. The optical coupler 73 splits the light propagated through the waveguide 72 into the number (9 in the illustrated example) of element sub-areas 21, and the splitted light passes through each waveguide 74 to be emitted from an end surface 74a toward the corresponding element lens 14 included in the lens array 13.

The lengths from the optical coupler 73 to the end surfaces of the waveguides 74 differ from each other, and the differences in length are longer than a coherence length l_{C} of the LD 76. Herein, let the wavelength of the LD 76 be λ, and the full width at half maximum of the LD 76 be Δλ, the coherence length l_{C} of the LD 76 may be represented by the following formula III.

$${l}_{c} = \frac{{λ}^{2}}{Δλ} \qquad ( Formula III )$$

For instance, when λ=635 nm and Δλ=0.2 nm, l_{C}=2.0 mm.

Furthermore, to reconstruct a hologram image, the coherence length l_{C} of the LD 76 is greater than or equal to the wavelength λ. Moreover, Δλ satisfies the following formula IV using the maximum half angle of view θ_{MAX}, the optical resolution θ_{R}, and the pitch p of the spatial light modulator.

Δλ≦2p(sin θ_{MAX}−sin θ_{R}) (Formula IV)

For example, when θ_{R}=9.5 deg, θ_{R}=1′, and p=1.6 μm, Δλ=0.9 nm.

Other parts of the configuration are the same as the first to the fourth embodiment, and the same constituent elements are denoted by the same reference numerals, and a description thereof is omitted. In the present embodiment also, the method of computing hologram data corresponding to a hologram pattern on the element sub-areas 21 is the same as that in the first embodiment.

According to the present embodiment, similarly to the first embodiment, the amount of operations for generating a hologram pattern is reduced. Furthermore, since the waveguides are splitted by using the optical coupler 73, the number of optical wave sources included in the light source unit 10 is reduced. Moreover, since the lengths from the optical coupler 73 to the end surfaces of the waveguides 74 differ from each other, and the differences in length are longer than the coherence length l_{C} of the LD 76, display beams emitted from the element sub-areas 21 do not interfere with each other, and accordingly, deterioration of the image due to interference is prevented.

### Sixth Embodiment

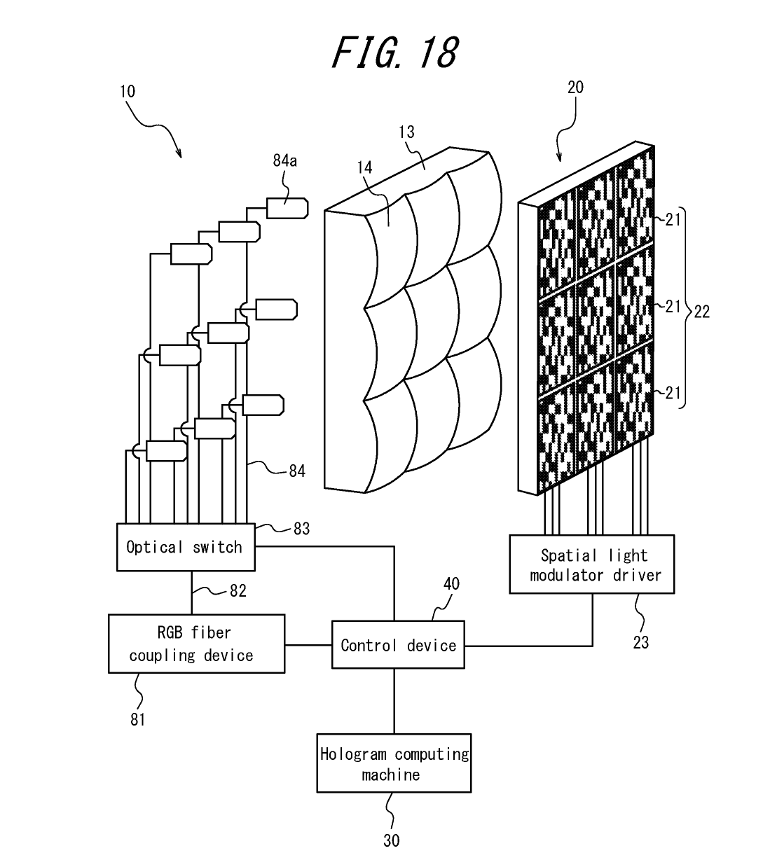

FIG. 18 illustrates a schematic configuration of a hologram image reconstruction device according to the sixth embodiment. The hologram image reconstruction device according to the sixth embodiment is similar to the hologram image reconstruction device according to the fifth embodiment, except for that the fiber coupling device 71 is replaced with an RGB fiber coupling device 81 and that the optical coupler 73 is replaced with an optical switch 83. The optical switch 83 is controlled by the control device 40. The waveguides 82 and 84 correspond to the waveguides 72 and 74 according to the fifth embodiment.

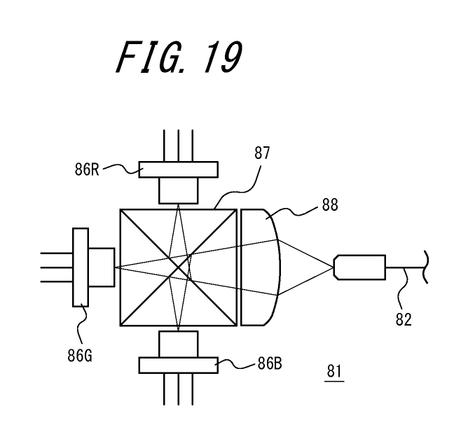

FIG. 19 illustrates a configuration of the RGB fiber coupling device 81 illustrated in FIG. 18. The configuration of the RGB fiber coupling device 81 resembles the configuration of the RGB light source 61 illustrated in FIG. 14. LDs 86R, 86G, and 86B of the RGB fiber coupling device 81 and a quarterly partitioned dichroic mirror 87 are respectively configured and arranged similarly to the LDs 62R, 62G, and 62B and the quarterly partitioned dichroic mirror 63. The RGB fiber coupling device 81 further includes a condensing lens 88 located on a reference beam emitting surface of the quarterly partitioned dichroic mirror 87 that opposes to a surface on which the LD 86G is located and from which laser beams are emitted, and thus, the laser beams are collected to an end surface of the waveguide 82. The LDs 86R, 86G, and 86B of the RGB fiber coupling device 81 are controlled by the control device 40. The optical switch 83 may selectively control a waveguide 84 to emit light and emit light only to a single waveguide 84 at once.

Other parts of the configuration are the same as the fifth embodiment, and the same constituent elements are denoted by the same reference numerals, and a description thereof is omitted. In the present embodiment also, the method of computing hologram data corresponding to a hologram pattern on the element sub-areas 21 is the same as that in the first embodiment.

In the present embodiment, the control device 40 sequentially switches the waveguides 84 to emit light via the optical switch 83 in synchronization with a change in hologram pattern of the spatial light phase modulator 20. Consequently, the element sub-area 21 to be irradiated with the reference beam is changed sequentially. By scanning while switching the element sub-areas 21 included in the light modulation area 22 sequentially, the element sub-areas 21 are prevented from emitting the display beams simultaneously. Accordingly, even when the eyes are located in a position at which display beams emitted form the holograms overlap with each other, deterioration in image quality due to interference is prevented.

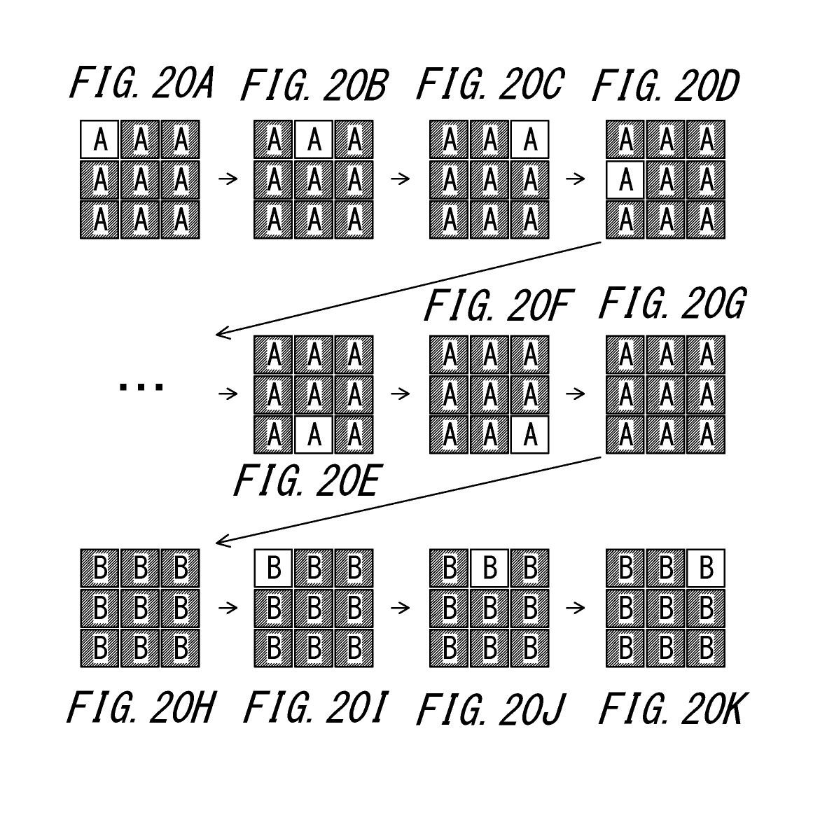

Examples of procedure of irradiating the element sub-areas 21 with the reference beam include a method, such as raster scan, of irradiating a sequence of element sub-areas 21 horizontally and sequentially, and then, each time the irradiation of one sequence is completed, an irradiated position is displaced vertically. FIGS. 20A to 20K illustrate control over display of hologram patterns. In FIGS. 20A to 20F, the image A is reconstructed from an upper left sub-area to a lower-right sub-area sequentially, and in FIGS. 20G and 20H, the image to be reconstructed is switched from A to B, that is to say, the hologram patterns are switched. Then, in FIGS. 20I and 20K onward, the image B is reconstructed. Herein, the image A and the image B represent different images including different color components. The element sub-areas 21 irradiated with the reference beam may be switched by the control device 40 controlling the LDs 86R, 86G, and 86B of the RGB fiber coupling device 81 and the optical switch 83. Switching the element sub-areas 21 that reconstruct a hologram image at a high speed allows an overall image on the light modulation area 22 to be observed. Thus, switching the element sub-areas 21 at a high speed provides an advantage of preventing occurrence of interference between display beams emitted from the plurality of element sub-areas 21.

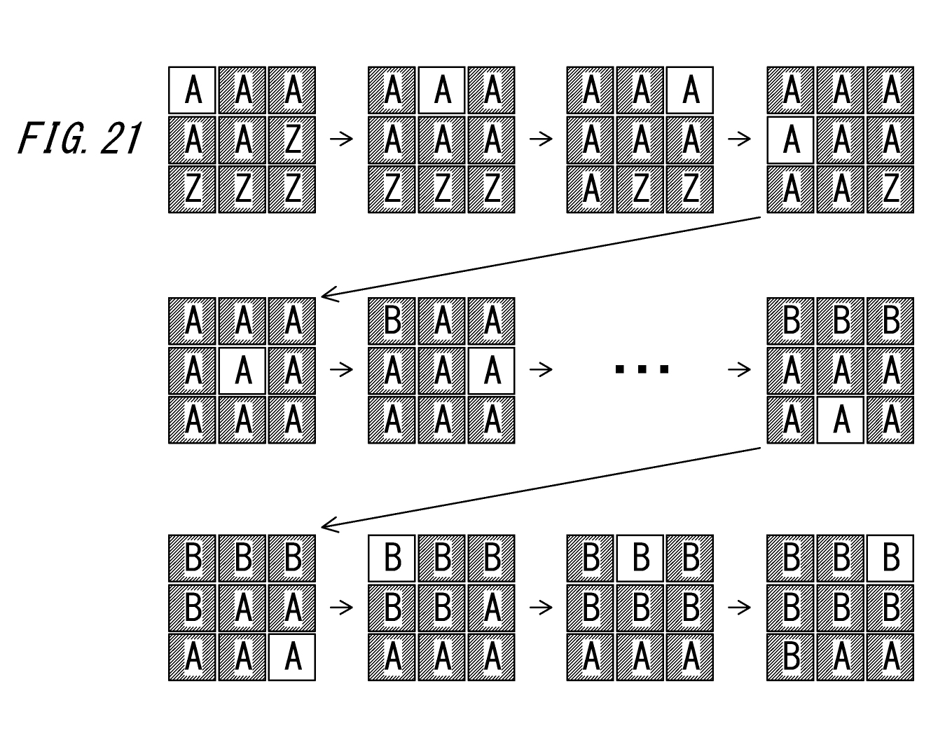

FIG. 21 illustrates a modification of control over display of hologram patterns. This modification is similar to the control over display illustrated in FIG. 20 in that the element sub-areas 21 are irradiated with a reference beam sequentially. However, this modification differs from the example illustrated in FIG. 20 in that hologram patterns are changed sequentially from one element sub-area 21 that has been irradiated with the reference beam while another element sub-area 21 is irradiated with the reference beam. By doing so, the time for all the hologram sub-areas to be switched off to rewrite all the element sub-areas 21 simultaneously is omitted, and accordingly, images that are flickerless and easier to see may be reconstructed.

### Seventh Embodiment

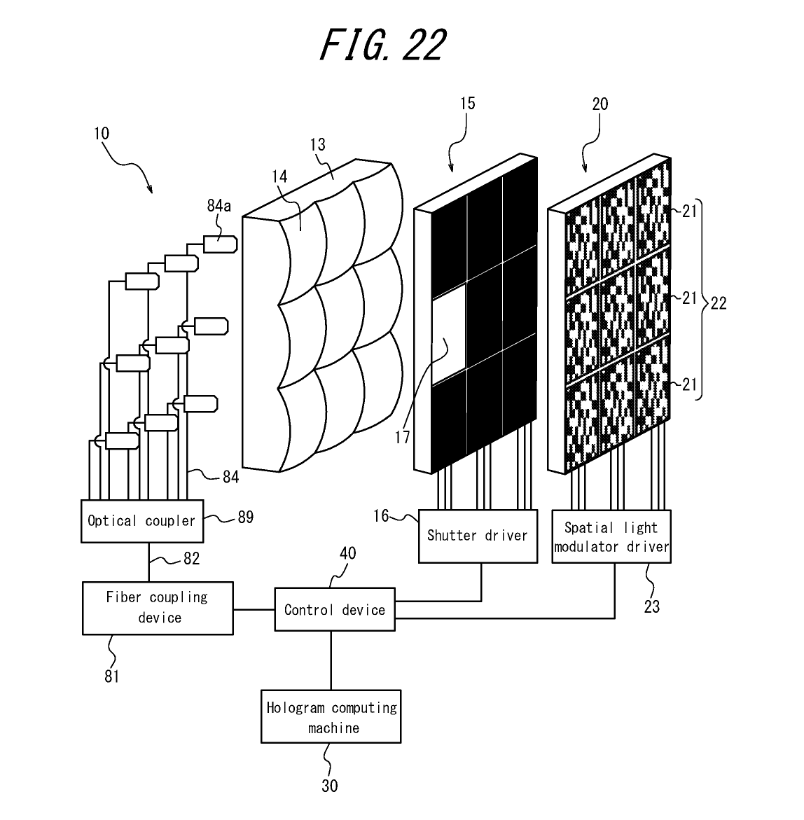

FIG. 22 illustrates a schematic configuration of a hologram image reconstruction device according to the seventh embodiment. This embodiment is similar to the sixth embodiment, except for that the optical switch 83 is replaced with an optical coupler 89, which splits light propagated from the RGB fiber coupling device 81 through the waveguide 82 into the waveguides 84.

On the other hand, between the lens array 13 and the light modulation area 22 of the spatial light phase modulator 20, there is provided a shutter device 15 including a plurality of window portions 17 corresponding to the element sub-areas 21 of the light modulation area 22. The shutter device 15 is, for example, a liquid crystal shutter that may be electrically controlled, and the shutter device 15 may change light transmittances of the window portions 17 momentarily. When any window portion 17 of the shutter device 15 is opened, the entire corresponding element sub-area 21 is ready to be irradiated with a reference beam, and when the window portion 17 of the shutter device 15 is closed, the entire corresponding element sub-area 21 is shielded from the reference beam. The shutter device 15 is controlled by the control device 40 via the shutter driver 16. Based on hologram data that the hologram computing machine 30 computes, the control device 40 controls a change on hologram patterns in the spatial light phase modulator 20, selection of laser emitted from the light source unit 10, and a change in light transmittances of the window portions 17, in synchronization.

Consequently, similarly to the sixth embodiment, by changing the element sub-areas 21 to be irradiated with the reference beam sequentially as in raster scan by opening and closing the window portions 17 of the shutter while changing laser wavelengths of the light source, a color hologram image may be reconstructed. Additionally, the shutter device 15 may be located on the side of a display beam emitting surface of the spatial light phase modulator 20. In the hologram image reconstruction device according to the present embodiment, since a plurality of display beams are not observed simultaneously, deterioration in image quality due to interference is prevented.

### Eighth Embodiment

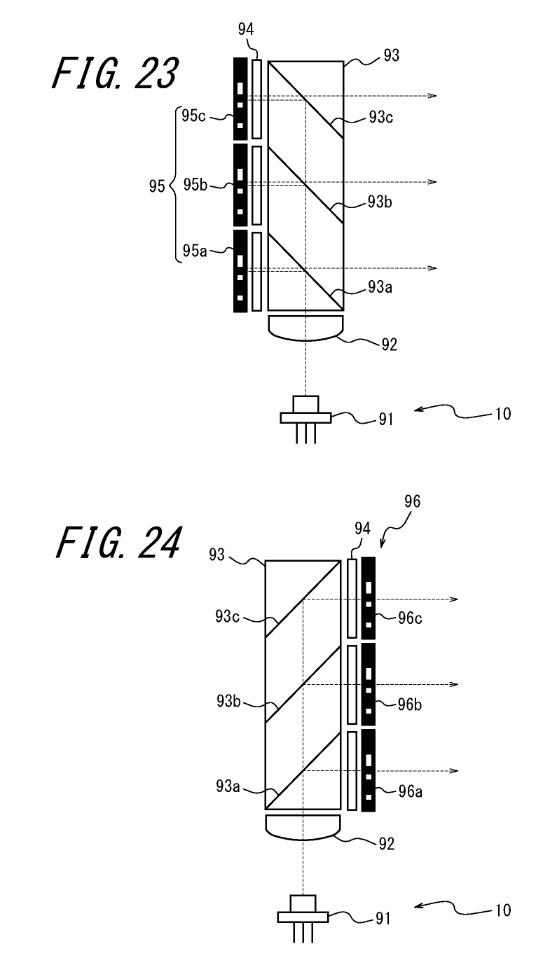

FIG. 23 illustrates a schematic configuration of a hologram image reconstruction device according to the eighth embodiment. The hologram image reconstruction device according to the present embodiment includes an LD 91 constituting the light source unit 10, a collimate lens 92, a polarization beam splitter 93, a plurality of λ/4 wavelength plates 94, an LCOS 95 which is a reflection type spatial light phase modulator, and the operation unit and the control unit which are not illustrated. FIG. 23 illustrates the hologram image reconstruction device, with a surface of the LCOS 95 on which a hologram image is formed being viewed from the very side thereof. The LCOS 95 has a depth that is sufficient to allow a hologram image to be observed.

Laser light emitted from the LD 91 is transformed to parallel light through the collimate lens 92 and emitted to the polarization beam splitter 93. The polarization beam splitter 93 includes, inside thereof, a plurality of splitting surfaces 93a, 93b, and 93c. Each of the splitting surfaces 93a, 93b, and 93c is inclined 45 degrees with respect to the lens axis of the collimate lens 92, that is to say, inclined 45 degrees with respect to laser light that is incident on the polarization beam splitter 93. Accordingly, part of s-polarized laser light is reflected toward the LCOS 95 located on the side of the polarization beam splitter 93. Furthermore, the splitting surfaces 93a, 93b, and 93c have different reflectivities and transmittances, and a splitting surface located closer to the LD 91 has a smaller reflectivity and a greater light transmittance. The reflectivities and the transmittances are designed to achieve a finally emitted display beam that is uniform across the surface of the LCOS 95. A laser beam (S-wave) reflected from the splitting surfaces 93a, 93b, and 93c is transmitted through the λ/4 wavelength plates 94 to be transformed into a circularly polarized beam, which is then incident on the light modulation area of the LCOS 95. The beam incident on the LCOS 95 is phase-modulated and reflected and then, transmitted through the λ/4 wavelength plates 94 to be transformed into a p-polarized display beam. Furthermore, the display beam is incident on the polarization beam splitter 93 and transmitted through the splitting surfaces 93a, 93b, and 93c.

Additionally, the LCOS and the λ/4 wavelength plates do not necessarily need to be separated physically.

The light modulation area of the LCOS 95 is divided into a plurality of element sub-areas 95a, 95b, and 95c. Although FIG. 23 only illustrates the light modulation area divided in the vertical direction, the light modulation area is also divided in the depth direction of the figure. Similarly to the hologram computing machine 30 according to the first embodiment, the operation unit included in the hologram image reconstruction device calculates the same hologram data for each of the element sub-areas 95a, 95b, and 95c, and, based on the computed hologram data, the control unit firms a hologram pattern over the entire light modulation area 22 of the LCOS 95. Accordingly, the present embodiment also allows computation of hologram data with a less amount of operations compared with cases where hologram data is computed for the entire light modulation device elements included in the LCOS 95.

By the display beams being reconstructed from thus formed hologram pattern, an observer may observe the hologram image produced as a virtual image. Furthermore, as described above, the amount of operations for hologram data is reduced. Moreover, since the polarization beam splitter 93 including the plurality of splitting surfaces 93a, 93b, and 93c is used, the number of light sources is reduced compared with cases where the element sub-areas 95a, 95b, and 95c are irradiated with individual light sources. Moreover, the use of the optical system in which a light path is deflected by the polarization beam splitter 93 helps realize the compact and thin device. Additionally, in the above description, an angle between parallel light incident on the polarization beam splitter 93 and each of the split surfaces 93a, 93b, and 93c is not limited to 45 degrees and may be set to various other angles.

### Ninth Embodiment

FIG. 24 illustrates a schematic configuration of a hologram image reconstruction device according to the ninth embodiment. The present embodiment is similar to the hologram image reconstruction device according to the eighth embodiment, except for that the λ/4 wavelength plates 94 are omitted and that a transmissive LCD 96 is employed. Accordingly, a laser beam reflected from the split surfaces 93a, 93b, and 93c is transmitted through the element sub-areas 96a, 96b, and 96c of the LCD 96. The laser beam, when being transmitted through the transmissive LCD 96, is phase-modulated to be emitted as a display beam. Other parts of the configuration and effect are the same as the eighth embodiment. Accordingly, similarly to the eighth embodiment, the compact and thin hologram image reconstruction device is achieved.

The present disclosure is not limited to the above embodiments, and various modifications and changes may be made. For example, the light modulation area does not necessarily need to be divided into 9, that is to say, 3×3. The dimension of each element sub-area only has to be greater than the dimension of the pupil of a human being. Accordingly, the light modulation area of the spatial light modulator may be divided into as many as several tens or more sub-areas both in the vertical and the horizontal direction. Furthermore, in the first embodiment illustrated in the flowchart of FIG. 3, the step (Step S01) of dividing the hologram data generation area into the element sub-areas only has to be performed before Step S04 of assigning hologram data of the base hologram area to the element sub-area and does not need to be performed before (Step S02 of) inputting data pertaining to an object to be displayed. For example, the hologram data generation area may be divided into the element sub-areas after Step S03 of computing hologram data of the base hologram. Moreover, the spatial light modulator is not limited to a spatial light phase modulator, and various devices, such as a spatial light intensity modulator configured to modulate amplitude of an optical wavefront of a beam and a device configured to modulate both phase distribution and intensity distribution, may be adopted as the spatial light modulator. Additionally, although in the embodiments an object to be reconstructed is described as being located at infinity, the object does not necessarily need to be located at infinity. A hologram image of the object may be reconstructed simply by computing hologram data under the assumption that the object is located far to some extent.

### REFERENCE SIGNS LIST

10 Light source unit

11 LD (laser diode)

12 Light source driver

13 Lens array

14 Element lens

15 Shutter device

16 Shutter driver

20 Spatial light phase modulator

21 Element sub-area (real space)

22 Light modulation area

23 Spatial light modulator driver

30 Hologram computing machine

31 Image

32 Base hologram area

33 Hologram data generation area

34 Element sub-area (virtual space)

35 Hologram data

36 Reconstructed image

31, 38 Border

40 Control device

50 Eyeball

51 Pupil

61 RGB light source

62R, 62G, 62B LD

63 Quarterly partitioned dichroic mirror

71 Fiber coupling device

72 Waveguide

73 Optical coupler

74 Waveguide

76 LD

77 Condensing lens

81 RGB fiber coupling device

82 Waveguide

83 Optical switch

84 Waveguide

86R, 86G, 86B LD

87 Quarterly partitioned dichroic mirror

88 Condensing lens

89 Optical coupler

91 LD (laser diode)

92 Collimate lens

93 Polarization beam splitter

94 λ/4 wavelength plate

95 LCOS

96 Transmissive LCD

1. A hologram data generation method for reconstructing a hologram image, comprising the steps of:
dividing a hologram data generation area, in which hologram data is generated, into a plurality of element sub-areas;
computing base hologram data that pertains to an area smaller than the hologram data generation area and that is to form an optical wavefront of an object to be reconstructed; and
assigning, as hologram data of the element sub-areas, hologram data of an entirety or a part of the area to which the base hologram data pertains.

2. The hologram data generation method of claim 1, wherein the base hologram data is computed with respect to the object to be reconstructed that is located at infinity.

3. The hologram data generation method of claim 1, further comprising the step of:
adding hologram data having converging or diverging power.

4. The hologram data generation method of claim 3, wherein the hologram data having converging or diverging power is added to the hologram data of the element sub-areas each assigned with the hologram data of the entirety or the part of the area to which the base hologram data pertains.

5. The hologram data generation method of claim 3, wherein
the hologram data having converging or diverging power is added to the base hologram data, and
hologram data in which the hologram data having converging or diverging power is added to the element sub-areas is generated, and the generated hologram data is assigned to the element sub-areas.

6. The hologram data generation method of claim 1, wherein the hologram data comprises data representing phase modulation amount.

7. The hologram data generation method of claim 1, wherein the element sub-areas have the same shape.

8. The hologram data generation method of claim 1, wherein any of the element sub-areas having the same shape are assigned with the same hologram data.

9. The hologram data generation method of claim 1, wherein the base hologram has the same shape as each element sub-area.

10. A hologram image reconstruction method, comprising the steps of:
dividing a hologram data generation area, in which hologram data is generated, into a plurality of element sub-areas;
computing base hologram data that pertains to an area smaller than the hologram data generation area and that is to form an optical wavefront of an object to be reconstructed;
assigning, as hologram data of the element sub-areas, hologram data of an entirety or a part of the area to which the base hologram data pertains;
generating a hologram pattern based on the hologram data of the hologram data generation area; and
irradiating the hologram pattern with a reference beam.

11. The hologram image reconstruction method of claim 10, wherein the object to be reconstructed is located at infinity.

12. The hologram image reconstruction method of claim 10, further comprising the step of:
adding hologram data having converging or diverging power.

13. The hologram image reconstruction method of claim 12, wherein the hologram data having converging or diverging power is added to the hologram data of the element sub-areas each assigned with the hologram data of the entirety or the part of the area to which the base hologram data pertains.

14. The hologram image reconstruction method of claim 12, wherein
the hologram data having converging or diverging power is added to the base hologram data, and
hologram data in which the hologram data having converging or diverging power is added to the element sub-areas is generated, and the generated hologram data is assigned to the element sub-areas.

15. The hologram image reconstruction method of claim 10, wherein the hologram data comprises data representing phase modulation amount.

16. The hologram image reconstruction method of claim 10, wherein the element sub-areas have the same shape.

17. The hologram image reconstruction method of claim 10, wherein any of the element sub-areas having the same shape are assigned with the same hologram data.

18. The hologram image reconstruction method of claim 10, wherein the base hologram has the same shape as each element sub-area.

19. A hologram image reconstruction device, comprising:
a light source unit;
a spatial light modulator that includes a light modulation area having a plurality of light modulation element devices and that is configured to modulate an optical wavefront from the light source unit;
an operation unit configured to compute hologram data of the light modulation area; and
a control unit configured to form a hologram pattern on the light modulation area included in the spatial light modulator based on the hologram data outputted from the operation unit, wherein
the operation unit divides the light modulation area included in the spatial light modulator into a plurality of element sub-areas, calculates hologram data pertaining to a base hologram that has a less number of light modulation element devices than the light modulation element devices of the light modulation area and that is to form an optical wavefront of an object to be reconstructed in response to irradiation of light from the light source unit, and generates the hologram data of the light modulation area by assigning, as hologram data of the element sub-areas, hologram data pertaining to an entirety or a part of an area of the base hologram.

20. The hologram image reconstruction device of claim 19, wherein hologram data of the base hologram is derived with respect to the object to be reconstructed that is located at infinity.

21. The hologram image reconstruction device of claim 19, wherein the operation unit is further configured to add hologram data having converging or diverging power.

22. The hologram image reconstruction device of claim 21, wherein the hologram data having converging or diverging power is added to the hologram data of the element sub-areas each assigned with the hologram data pertaining to the entirety or the part of the area of the base hologram.

23. The hologram image reconstruction device of claim 21, wherein
the hologram data having converging or diverging power is added to the hologram data of the base hologram, and
hologram data in which the hologram data having converging or diverging power is added to the element sub-areas is generated, and the generated hologram data is assigned to the element sub-areas.

24. The hologram image reconstruction device of claim 19, wherein the spatial light modulator comprises a spatial light phase modulator that modulates spatial phase distribution of an incident optical wavefront.

25. The hologram image reconstruction device of claim 19, wherein the element sub-areas have the same shape.

26. The hologram image reconstruction device of claim 19, wherein any of the element sub-areas having the same shape are assigned with the same hologram data.

27. The hologram image reconstruction device of claim 19, wherein the base hologram has the same shape as each element sub-area.

28. The hologram image reconstruction device of claim 19, wherein the element sub-areas each have a dimension that covers a circle having a diameter of 3 mm.

29. The hologram image reconstruction device of claim 19, wherein the light from the light source unit is designed to be incident on each element sub-area as a reference beam having an optical wavefront of the same shape.

30. The hologram image reconstruction device of claim 29, wherein the light source unit includes a plurality of optical wave sources in correspondence with the element sub-areas and also includes a wavefront formation unit configured to form an optical wavefront of a beam from each optical wave source into a desired shape.

31. The hologram image reconstruction device of claim 29, wherein the light source unit includes a less number of optical wave sources than the element sub-areas and also includes a wavefront formation unit configured to form an optical wavefront of a beam from each optical wave source into a plane shape.

32. The hologram image reconstruction device of claim 19, wherein one or more of the element sub-areas are irradiated with a reference beam emitted from the spatial light modulator sequentially.

33. The hologram image reconstruction device of claim 19, wherein the control unit is configured to control the light modulation element devices included in the spatial light modulator, with respect to each element sub-area individually.
